(19) United States
(12) Patent Application Publication
(10) Pub. No.: US 2026/0235750 A1
(43) Pub. Date: Aug. 13, 2026

(54) DISTRIBUTED SENSING WITH ASSISTING NODES

(71) Applicant: QUALCOMM Incorporated, San Diego, CA (US)

(72) Inventors: Preeti KUMARI, San Diego, CA (US); Anantharaman BALASUBRAMANIAN, San Diego, CA (US); Kapil GULATI, Belle Mead, NJ (US); Sourjya DUTTA, San Diego, CA (US); Stelios STEFANATOS, San Diego, CA (US); Junyi LI, Greentown, PA (US)

(21) Appl. No.: 19/157,600

(22) PCT Filed: Apr. 2, 2024
(86) PCT No.: PCT/US2024/022620

§ 371 Date: Aug. 18, 2025

(30) Foreign Application Priority Data
Apr. 4, 2023 (GR) 20230100281

(51) Int. Cl. G01S 13/89; G01S 13/58; H04W 16/14

(52) U.S. Cl. CPC G01S 13/89; G01S 13/58; H04W 16/14

(57) ABSTRACT

Methods, systems, and devices for wireless communications are described. A wireless device may transmit a message, in particular to a centralized controller or network entity, that includes a request for assistance to perform distributed sensing to characterize a target communication device using one or more assisting devices. The network entity may detect one or more assisting devices for the wireless device to use to perform distributed sensing, and may transmit a distributed sensing assistance message to the wireless device in response to the request. The distributed sensing assistance message may include configuration information for the one or more assisting devices to use to perform the distributed sensing. The wireless device may then perform the distributed sensing with the one or more assisting devices, and may receive sensing output information from the one or more assisting devices in accordance with the distributed sensing.

### CROSS REFERENCE

The present Application is a 371 national stage filing of International PCT Application No. PCT/US2024/022620 by KUMARI et al., entitled “DISTRIBUTED SENSING WITH ASSISTING NODES,” filed Apr. 2, 2024; and claims priority to and the benefit of Greek Patent Application No. 20230100281 by KUMARI et al. entitled “DISTRIBUTED SENSING WITH ASSISTING NODES,” filed Apr. 4, 2023, each of which is assigned to the assignee hereof, and each of which is expressly incorporated by reference in its entirety herein.

### FIELD OF TECHNOLOGY

The following relates to wireless communications, including distributed sensing with assisting nodes.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a wireless communications system may be a joint communication-radar (JCR) system that supports both wireless and radar signaling to increase wireless detection and sensing capabilities.

### SUMMARY

The described techniques relate to improved methods, systems, devices, and apparatuses that support distributed sensing with assisting nodes. For example, the described techniques provide for efficiently configuring sets of assisting devices to aid a wireless device accurately perform distributed sensing in a joint communication-radar (JCR) system. For example, after performing monostatic sensing, the wireless device may determine to switch to a multi-static or distributed sensing mode to better characterize a communications target. The wireless device may transmit a message to a centralized controller or network entity that includes a request for assistance to perform the distributed sensing to characterize the target communication device using one or more assisting devices such as one or more receiving devices, one or more reconfigurable intelligent surfaces (RISs), one or more transmitting devices, one or more reflectors, one or more repeaters, or any combination thereof. The network entity may detect one or more assisting devices (e.g., one or more pairs of assisting devices) for the wireless device to use to perform distributed sensing, and may transmit a distributed sensing information message to the wireless device in response to the request. The distributed sensing assistance message may include configuration information for the one or more assisting devices to use to perform the distributed sensing. The wireless device may then perform the distributed sensing with the one or more assisting devices, and may receive a first set of sensing output information from the one or more assisting devices.

A method for wireless communications at a wireless device is described. The method may include transmitting a message including a request for assistance to perform distributed sensing to characterize a target communication device via a set of multiple assisting devices, receiving a distributed sensing information message in response to the request, the distributed sensing information message including configuration information for one or more assisting devices to use to perform the distributed sensing, performing the distributed sensing with the one or more assisting devices based on the configuration information, and receiving a first set of sensing output information from the one or more of assisting devices in accordance with the distributed sensing.

An apparatus for wireless communications at a wireless device is described. The apparatus may include a processor, memory coupled with the processor, and instructions stored in the memory. The instructions may be executable by the processor to cause the apparatus to transmit a message to a network entity including a request for assistance to perform distributed sensing to characterize a target communication device via a set of multiple assisting devices, receive a distributed sensing information message in response to the request, the distributed sensing information message including configuration information for one or more of assisting devices to use to perform the distributed sensing, perform the distributed sensing with the one or more assisting devices based on the configuration information, and receive a first set of sensing output information from the one or more assisting devices in accordance with the distributed sensing.

Another apparatus for wireless communications at a wireless device is described. The apparatus may include means for transmitting a message to a network entity including a request for assistance to perform distributed sensing to characterize a target communication device via a set of multiple assisting devices, means for receiving a distributed sensing information message in response to the request, the distributed sensing information message including configuration information for one or more assisting devices to use to perform the distributed sensing, means for performing the distributed sensing with the one or more assisting devices based on the configuration information, and means for receiving a first set of sensing output information from the one or more assisting devices in accordance with the distributed sensing.

A non-transitory computer-readable medium storing code for wireless communications at a wireless device is described. Similarly, a computer program comprising code for wireless communications at a wireless device is described. The following explanations concerning the non-transitory computer-readable medium similarly apply to the computer program. The code may include instructions executable by a processor to transmit a message to a network entity including a request for assistance to perform distributed sensing to characterize a target communication device via a set of multiple assisting devices, receive a distributed sensing information message in response to the request, the distributed sensing information message including configuration information for one or more assisting devices to use to perform the distributed sensing, perform the distributed sensing with the one or more assisting devices based on the configuration information, and receive a first set of sensing output information from the one or more assisting devices in accordance with the distributed sensing.

In some examples of the method, apparatuses, and non-transitory computer-readable medium described herein, the distributed sensing information message further includes location information corresponding to the one or more assisting devices and the method, apparatuses, and non-transitory computer-readable medium may include further operations, features, means, or instructions for translating, based on the location information, the first set of sensing output information in a first reference system of the one or more assisting devices to a second set of sensing output information in a second reference system of the wireless device and combining the second set of sensing output information with a third set of sensing output information of the wireless device.

In some examples of the method, apparatuses, and non-transitory computer-readable medium described herein, transmitting the request for assistance to perform the distributed sensing may include operations, features, means, or instructions for transmitting a relative location of the wireless device, a relative orientation of the wireless device, one or more motion parameters associated with the wireless device, an estimate of the relative location of the target communication device, or any combination thereof.

In some examples of the method, apparatuses, and non-transitory computer-readable medium described herein, the distributed sensing information message further includes an indication of a transmit waveform including one or more waveform parameters, one or more beamforming parameters, a resource allocation for performing the distributed sensing, or any combination thereof.

In some examples of the method, apparatuses, and non-transitory computer-readable medium described herein, the one or more assisting devices including at least one receiving device and at least one assisting node.

In some examples of the method, apparatuses, and non-transitory computer-readable medium described herein, receiving the first set of sensing output information may include operations, features, means, or instructions for receiving the first set of sensing output information as one or more sensing outputs from each assisting device of the one or more assisting devices and combining the one or more sensing outputs at the wireless device in accordance with the distributed sensing information message.

In some examples of the method, apparatuses, and non-transitory computer-readable medium described herein, receiving the first set of sensing output information may include operations, features, means, or instructions for receiving, from the network entity, the first set of sensing output information as a combined set of sensing outputs from each assisting device of the one or more assisting devices.

In some examples of the method, apparatuses, and non-transitory computer-readable medium described herein, the first set of sensing output information includes a set of location and velocity parameters corresponding to a point cloud of the target communication device, one or more range parameters of the target communication device, one or more angle parameters of the target communication device, one or more velocity parameters of the target communication device, or any combination thereof.

In some examples of the method, apparatuses, and non-transitory computer-readable medium described herein, the first set of sensing output information includes a raw signal collected by the one or more assisting devices.

In some examples of the method, apparatuses, and non-transitory computer-readable medium described herein, the wireless device includes an initiator wireless node, and transmitting the request for assistance may include operations, features, means, or instructions for switching from a monostatic receiving mode to a distributed sensing mode for performing the distributed sensing and transmitting the request for assistance to perform the distributed sensing via the one or more assisting devices, where the one or more assisting devices include one or more receiving wireless devices, one or more transmitting wireless devices, one or more assisting nodes, or any combination thereof.

In some examples of the method, apparatuses, and non-transitory computer-readable medium described herein, the one or more assisting devices may be selected based on relative locations of the one or more assisting devices, one or more capabilities of the one or more assisting devices, a sensing coverage area associated with the one or more assisting devices, one or more key performance indicators (KPIs) associated with the one or more assisting devices, or any combination thereof.

In some examples of the method, apparatuses, and non-transitory computer-readable medium described herein, receiving the distributed sensing information message may include operations, features, means, or instructions for receiving the distributed sensing information message via a sidelink configured grant from an assisting device of the one or more assisting devices.

In some examples of the method, apparatuses, and non-transitory computer-readable medium described herein, receiving the distributed sensing information message may include operations, features, means, or instructions for receiving the distributed sensing information message via a downlink grant from the network entity.

In some examples of the method, apparatuses, and non-transitory computer-readable medium described herein, the one or more assisting devices includes one or more receiving devices, one or more RISs, one or more transmitting devices, one or more reflectors, one or more repeaters, or any combination thereof.

A method for wireless communications at a network entity is described. The method may include receiving a message from a wireless device including a request for assistance to perform distributed sensing via one or more assisting devices in a coverage area to characterize a target communication device, detecting one or more assisting devices for the wireless device to use to perform the distributed sensing, and transmitting a distributed sensing information message in response to the request, the distributed sensing information message including configuration information relating to the one or more assisting devices to use to perform the distributed sensing.

An apparatus for wireless communications at a network entity is described. The apparatus may include a processor, memory coupled with the processor, and instructions stored in the memory. The instructions may be executable by the processor to cause the apparatus to receive a message from a wireless device including a request for assistance to perform distributed sensing via one or more assisting devices in a coverage area to characterize a target communication device, detect one or more assisting devices for the wireless device to use to perform the distributed sensing, and transmit a distributed sensing information message in response to the request, the distributed sensing information message including configuration information relating to the one or more assisting devices to use to perform the distributed sensing.

Another apparatus for wireless communications at a network entity is described. The apparatus may include means for receiving a message from a wireless device including a request for assistance to perform distributed sensing via one or more assisting devices in a coverage area to characterize a target communication device, means for detecting one or more assisting devices for the wireless device to use to perform the distributed sensing, and means for transmitting a distributed sensing information message in response to the request, the distributed sensing information message including configuration information relating to the one or more assisting devices to use to perform the distributed sensing.

A non-transitory computer-readable medium storing code for wireless communications at a network entity is described. Similarly, a computer program comprising code for wireless communications at a network entity is described. The following explanations concerning the non-transitory computer-readable medium similarly apply to the computer program. The code may include instructions executable by a processor to receive a message from a wireless device including a request for assistance to perform distributed sensing via one or more assisting devices in a coverage area to characterize a target communication device, detect one or more assisting devices for the wireless device to use to perform the distributed sensing, and transmit a distributed sensing information message in response to the request, the distributed sensing information message including configuration information relating to the one or more assisting devices to use to perform the distributed sensing.

In some examples of the method, apparatuses, and non-transitory computer-readable medium described herein, the distributed sensing information message further includes location information for a first set of sensing output information to be translated from a first reference frame of the one or more assisting devices to a second reference frame of the wireless device.

In some examples of the method, apparatuses, and non-transitory computer-readable medium described herein, receiving the request for assistance to perform the distributed sensing may include operations, features, means, or instructions for receiving, from the wireless device, a relative location of the wireless device (e.g., a location in which the wireless device is located in space), a relative orientation of the wireless device, one or more motion parameters associated with the wireless device, an estimate of the relative location of the target communication device, or any combination thereof.

In some examples of the method, apparatuses, and non-transitory computer-readable medium described herein, the distributed sensing information message further includes an indication of a transmit waveform including one or more waveform parameters, one or more beamforming parameters, a resource allocation for performing the distributed sensing, or any combination thereof.

In some examples of the method, apparatuses, and non-transitory computer-readable medium described herein, the one or more assisting devices include at least one receiving device and at least one assisting node.

Some examples of the method, apparatuses, and non-transitory computer-readable medium described herein may further include operations, features, means, or instructions for transmitting, to the wireless device, a first set of sensing output information as a combined set of sensing outputs from each assisting device of the one or more assisting devices.

In some examples of the method, apparatuses, and non-transitory computer-readable medium described herein, the first set of sensing output information includes a set of location and velocity parameters corresponding to a point cloud of the target communication device, one or more range parameters of the target communication device, one or more angle parameters of the target communication device, one or more velocity parameters of the target communication device, or any combination thereof.

In some examples of the method, apparatuses, and non-transitory computer-readable medium described herein, receiving the request for assistance may include operations, features, means, or instructions for receiving, from the wireless device, the request for assistance to perform the distributed sensing via the one or more assisting devices, where the one or more assisting devices include one or more receiving wireless devices, one or more transmitting wireless devices, one or more assisting nodes, or any combination thereof.

In some examples of the method, apparatuses, and non-transitory computer-readable medium described herein, the one or more assisting devices may be selected based on relative locations of the one or more assisting devices, one or more capabilities of the one or more assisting devices, a sensing coverage area associated with the one or more assisting devices, one or more KPIs associated with the one or more assisting devices, or any combination thereof.

In some examples of the method, apparatuses, and non-transitory computer-readable medium described herein, transmitting the distributed sensing information message may include operations, features, means, or instructions for transmitting a sidelink configured grant for communicating the distributed sensing information message with the wireless device via an assisting device of the one or more assisting devices.

In some examples of the method, apparatuses, and non-transitory computer-readable medium described herein, transmitting the distributed sensing information message may include operations, features, means, or instructions for transmitting the distributed sensing information message via a downlink grant to the wireless device.

Some examples of the method, apparatuses, and non-transitory computer-readable medium described herein may further include operations, features, means, or instructions for selecting the one or more assisting devices based on adaptable analog to digital conversion (ADC) capabilities of one or more assisting devices and configuring the one or more assisting devices with respective ADC resolutions in accordance with the adaptable ADC capabilities.

In some examples of the method, apparatuses, and non-transitory computer-readable medium described herein, the respective ADC resolutions include low resolution ADC resolutions.

In some examples of the method, apparatuses, and non-transitory computer-readable medium described herein, the one or more assisting devices include one or more receiving devices, one or more RISs, one or more transmitting devices, one or more reflectors, one or more repeaters, or any combination thereof.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 illustrates an example of a wireless communications system that supports distributed sensing with assisting nodes in accordance with one or more aspects of the present disclosure.

FIG. 2 illustrates an example of a network architecture that supports distributed sensing with assisting nodes in accordance with one or more aspects of the present disclosure.

FIGS. 3 and 4 illustrates examples of joint communications-radar (JCR) systems that support distributed sensing with assisting nodes in accordance with one or more aspects of the present disclosure.

FIG. 5 illustrates an example of a process flow that supports distributed sensing with assisting nodes in accordance with one or more aspects of the present disclosure.

FIGS. 6 and 7 illustrate block diagrams of devices that support distributed sensing with assisting nodes in accordance with one or more aspects of the present disclosure.

FIG. 8 illustrates a block diagram of a communications manager that supports distributed sensing with assisting nodes in accordance with one or more aspects of the present disclosure.

FIG. 9 illustrates a diagram of a system including a device that supports distributed sensing with assisting nodes in accordance with one or more aspects of the present disclosure.

FIGS. 10 and 11 illustrate block diagrams of devices that support distributed sensing with assisting nodes in accordance with one or more aspects of the present disclosure.

FIG. 12 illustrates a block diagram of a communications manager that supports distributed sensing with assisting nodes in accordance with one or more aspects of the present disclosure.

FIG. 13 illustrates a diagram of a system including a device that supports distributed sensing with assisting nodes in accordance with one or more aspects of the present disclosure.

FIGS. 14 through 17 illustrate flowcharts showing methods that support distributed sensing with assisting nodes in accordance with one or more aspects of the present disclosure.

### DETAILED DESCRIPTION

Some wireless systems may support joint communication and radar (JCR) communications, where information is shared between communication and radar systems to improve performance and enhance target detection and sensing. For example, JCR systems may implement monostatic sensing, distributed sensing, or both, to accurately sense surrounding objects or target devices. For example, distributed sensing uses widely separated transmitters and receivers that are time synchronized (or time and phase synchronized) to increase spatial diversity, improve velocity estimates for moving targets, and improve target localization and characterization. In some cases, however, distributed sensing may be affected by channel conditions such as blockage and the system having a relatively limited number of transmitter and receiver nodes. Thus, enhancements to distributed sensing using assisting nodes (such as reconfigurable intelligent surfaces (RIS), repeaters, passive reflectors, and other assisting devices) may increase distributed sensing performance and to provide a more dynamic framework for collecting and sharing sensing information.

To support distributed sensing using assisting nodes, some systems may use a centralized controller such as a network entity to aggregate and distribute distributed sensing information to multiple nodes in the system, and to identify preferred or “optimal” configurations of assisting nodes to help a wireless device accurately characterize a target communication device. For example, a wireless device such as a transmitting node (e.g., Tx-0) may sense a target communication device using a monostatic sensing mode, and may determine to switch from the monostatic sensing mode to a distributed sensing mode to obtain more detailed information about the target communication device (such as shape, velocity, object type, etc.). The transmitting node may send a request to the central controller or network entity to assist the transmitting node with distributed sensing using additional receiving nodes and assisting nodes. Along with the request, the transmitting node sends its own location, orientation, motion parameters, and a location estimate of the target communication device. In response, the transmitting node receives transmit waveform and beamforming configurations as well as a resource allocation from the centralized controller based on its distributed sensing request.

The centralized controller may then assist the transmitting node to select a set of receiving nodes and assisting nodes in the system to help the transmitting node more accurately perform distributed sensing. For example, the centralized controller may send distributed sensing information (DS info) to the transmitting node that includes assisting node location, along with information that allows the transmitting node to translate sensing outputs from the assisting nodes in its own reference system, also referred to as its own reference frame. This DS info allows the transmitting node to combine information received from the assisting nodes with its own sensing output to more accurately and efficiently characterize the target communication device. After receiving the DS info from the centralized controller, the transmitting node may transmit a message requesting sensing outputs, and may correspondingly collect distributed sensing outputs from multiple widely separated receiving nodes or assisting nodes (or receives aggregated information directly from the centralized controller).

In some implementations, to further support the transmitting node, the centralized controller may inform different receiving nodes of assisting node location and the location of the transmitting node so that the receiving nodes can automatically translate the frame of reference of the sensing data outputs to be from the transmitting node's frame of reference. Such sensing data output from receiving nodes could include, for example, location and velocity parameters corresponding to target communication device, center and spread of the range of the target communication device, angle, and velocity parameters, among other information.

In addition or in alternative, the transmitting node may send, in a broadcast, a request to assist the transmitting node with distributed sensing using additional receiving nodes and assisting nodes and the additional receiving nodes or/and assisting nodes may send the distributed sensing information to the transmitting node.

Aspects of the disclosure are initially described in the context of wireless communications systems. Aspects of the disclosure are further illustrated by JCR systems and a process flow, and are further described with reference to apparatus diagrams, system diagrams, and flowcharts that relate to distributed sensing with assisting nodes.

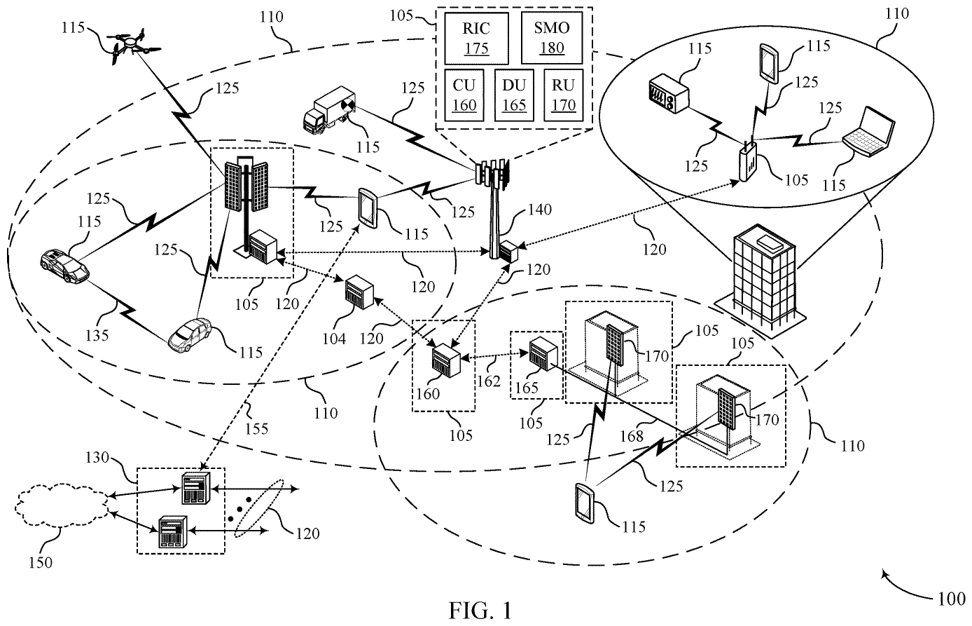

FIG. 1 illustrates an example of a wireless communications system 100 that supports distributed sensing with assisting nodes in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support distributed sensing with assisting nodes as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some communication and radar systems are separately designed, and may utilize different frequency bands, waveforms, performance criteria, and other applications. For example, some radar systems may occupy wider bandwidths compared to some wireless communications systems, due to relatively large bandwidths used for satisfactory range resolution. In some cases, however, mmW systems and other high frequency communications systems may accommodate an increased number of antennas to enable spectrum sharing and beamforming for radar and wireless communications systems.

In some examples, systems that share both communications system and radar functionalities may be joint communication-radar (JCR) systems, and may implement radar functions in a wireless communication system platform. For example, in some JCR systems, one or more hardware components of the communications system may be re-used for the radar, spectrum sharing may occur between the communications system and radar system, or both. In such cases, the addition of radar communications may increase sensing capabilities, communication reliability, and overall system performance. In some examples, a communications system and a radar system may support JCR, which may have increased detection performance relative to TDM detection techniques (e.g., irrespective of communication and sensing directions). For example, the addition of radar sensing using data to communications system may enhance JCR performance relative to TDM.

A JCR system may be categorized as a cooperative JCR system, a co-design JCR system, or a co-habitation JCR system. In a cooperative JCR system, some system knowledge or system information is shared between the communication and radar systems to increase performance of the system while maintaining core operations of both the radar and communications systems. Such examples of cooperative JCR systems may support radio frequency spectrum re-use or sharing between the communication and radar system, which may increase the implementation efficiency for JCR systems. In some examples, a cooperative JCR system may support opportunistic spectrum access approach, where one device may be a primary user that accesses the channel, and another device may be a secondary user which waits to access the channel.

In a co-design of JCR system, a common transmitting node or receiving node may be used for both communication and radar functionalities. In co-designed systems, an integrated waveform (e.g., a modified transmit waveform) and modified signal processing techniques may be employed jointly handle the communication and radar functions on one hardware platform. Co-designed systems may also re-use device hardware for communication and radar, and may employed a shared spectrum for communications.

In some other implementations such as a cohabitation implementation, where radar and communication systems access the same frequency band simultaneously and in a same coverage area. In such implementations, each signal (e.g., a communications signal or a radar signal) may act as interference for the other system. To keep interference within a threshold limit, radar and communication systems may exchange information such as quality-of-service (QOS) requirements, and devices may perform successive interference cancellation to reduce interference.

Some radar systems may implement CP-OFDM data for radar sensing. For example, a system may support a multi-FFT algorithm if the OFDM symbol length is less than the radar channel delay spread for radar sensing, detection and estimation. Such multi-FFT per symbol algorithms may meet threshold distance detection for automotive ranges (e.g., 300 meters in single-target scenario) within threshold detectable SINR (e.g., 15 dB).

In some examples, a JCR system may increase energy savings (and correspondingly mitigate symbol energy loss due to long delay spread) using one-tap frequency domain estimation (FDE) with multi-FFT windows per symbol. For example, a device may detect a target using FFT and IFFT techniques using a window with 480 kHz SCS that is aligned to minimize delay and cyclic prefix duration. The device may sense a target and perform an FFT or IFFT within a first range window for a k^{th} symbol (e.g., using a one-tap FDE with single-FFT window per symbol). The device may also sense a same target or a different target within a second range window and perform an FFT or an IFFT for a k^{th} symbol. In such cases, detection may start where the first window corresponding to the symbol ends to fully capture the received k^{th} symbol. In some examples, the device may perform multi-FFT per symbol target detection, using a first range-Doppler (RD) map estimate with high target SINR for small ranges (with delay bin (d) less than ¼^{th} of FFT size (MFFT), for example, d<M_{FFT}/4 ). In some other examples, the RD map estimate may have high target SINR for large ranges (e.g., d>3M_{FFT}/4). A combined RD map may then be obtained by adding both the RD map estimates to achieve high target SINR for medium ranges (e.g., M_{FFT}/4<d<3M_{FFT}/4). In such examples, a device may detect a target if targets are present in near, middle or far spatial ranges.

In some implementations, the wireless communications system 100 may be an example of a JCR system that implements monostatic sensing, distributed sensing, or both, using both radar and wireless communications to accurately sense surrounding objects or target devices. For example, distributed sensing for JCR systems uses widely separated transmitters and receivers to improve target localization and characterization. In some cases, however, distributed sensing may be affected by channel conditions such as blockage and the system having a relatively limited number of transmitter and receiver nodes. Thus, enhancements to distributed sensing using assisting nodes (such as RIS, repeaters, passive reflectors, and other assisting devices) may increase distributed sensing performance. In some examples, the monostatic sensing may implement a same antenna (or virtually coincident or collocated antenna arrays) for transmitting and receiving signals at a same device located at a single location. In some other examples, the distributed sensing may implement multiple different antennas for transmitting and receiving signals at multiple devices located at one or more different locations of the wireless communications system 100.

To support distributed sensing using assisting nodes, some systems may use a centralized controller such as a network entity 105 to aggregate and distribute distributed sensing information to multiple nodes in the system, and to identify various configurations of assisting nodes to help a wireless device such as a UE 115 accurately characterize a target communication device. For example, a wireless device such as a transmitting node or UE 115 (e.g., Tx-0) may sense a target communication device using a monostatic sensing mode, and may determine to switch from the monostatic sensing mode to a distributed sensing mode to obtain more detailed information about the target communication device. The UE 115 may send a request to the network entity 105 to assist the UE 115 with distributed sensing using additional receiving nodes and assisting nodes.

The network entity 105 may then assist the UE 115 to select a set of receiving nodes and assisting nodes in the system to help the UE 115 more accurately perform distributed sensing. For example, the network entity 105 may send distributed sensing information (DS info) to the UE 115 that includes assisting node location, along with information that allows the UE 115 to translate sensing outputs from the assisting nodes in its own reference frame. This DS info may allow the UE 115 to combine information received from the assisting nodes with its own sensing output to more accurately and efficiently characterize the target communication device. After receiving the DS info from the network entity 105, the UE 115 sends a transmit signal and collects distributed sensing outputs from multiple widely separated receiving nodes or assisting nodes (or receives aggregated information directly from the network entity 105).

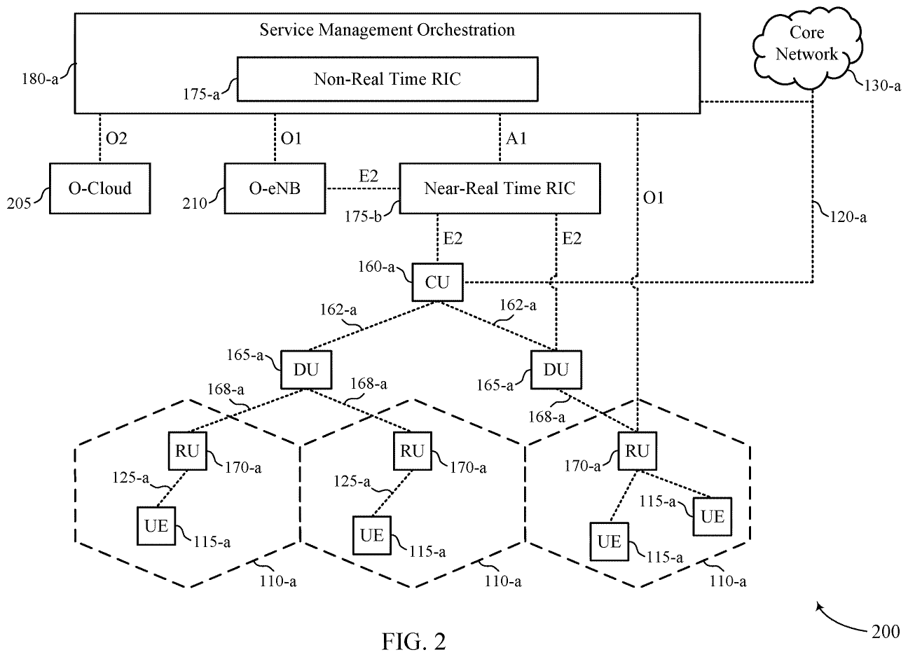

FIG. 2 illustrates an example of a network architecture 200 (e.g., a disaggregated base station architecture, a disaggregated RAN architecture) that supports distributed sensing with assisting nodes in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with a UE 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an El interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an Al interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

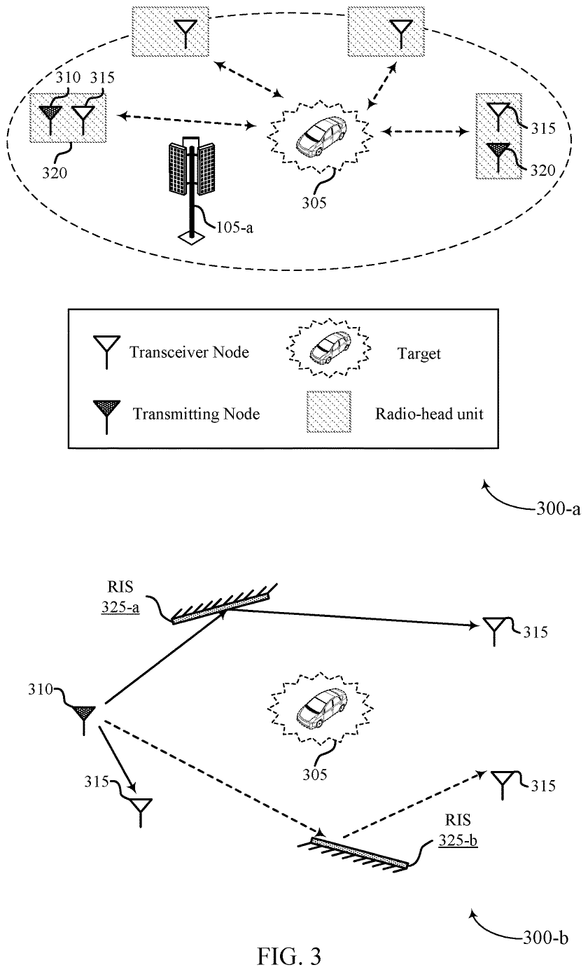

FIG. 3 illustrates an example of JCR systems 300-a and 300-b that support distributed sensing with assisting nodes in accordance with one or more aspects of the present disclosure. For example, JCR systems 300-a and 300-b may support communications between communications devices such as various transmitting nodes 310 and transceiver nodes 315 (which may be examples of UEs 105 or network entities 105 described with reference to FIG. 1), a centralized controller or network entity 105-a (which may be an example of a network entity 105 described with reference to FIG. 1), and one or more assisting devices (for example, RIS 325-a and RIS 325-b).

Some wireless systems may support JCR communications, where information is shared between the communication and radar systems to improve performance. JCR systems may implement monostatic sensing (using an individual monostatic JCR unit), distributed sensing (using multiple sensing or assisting devices), or both, to accurately sense surrounding objects or target devices. For example, distributed sensing may implement widely separated transmitting nodes and receiving nodes that are time synchronized (or time and phase synchronized) to exploit (e.g., increase) spatial diversity, improve velocity estimates for a moving target or multiple targets moving in various arbitrary directions, to achieve high resolution target localization, and to increase the quality of target characterization by enhancing target shape and volume estimation by achieving a relatively dense point cloud estimation for the target. In some cases, however, JCR systems may implement different assisted distributed sensing techniques to overcome challenging channel conditions such as blockage and the system having a relatively limited number of transmitting and receiving node nodes. Thus, enhancements to distributed sensing using assisting nodes (such as reconfigurable intelligent surfaces (RIS), repeaters, passive reflectors, etc.) are desired to improve distributed sensing performance and to provide a more dynamic framework for collecting and sharing sensing information.

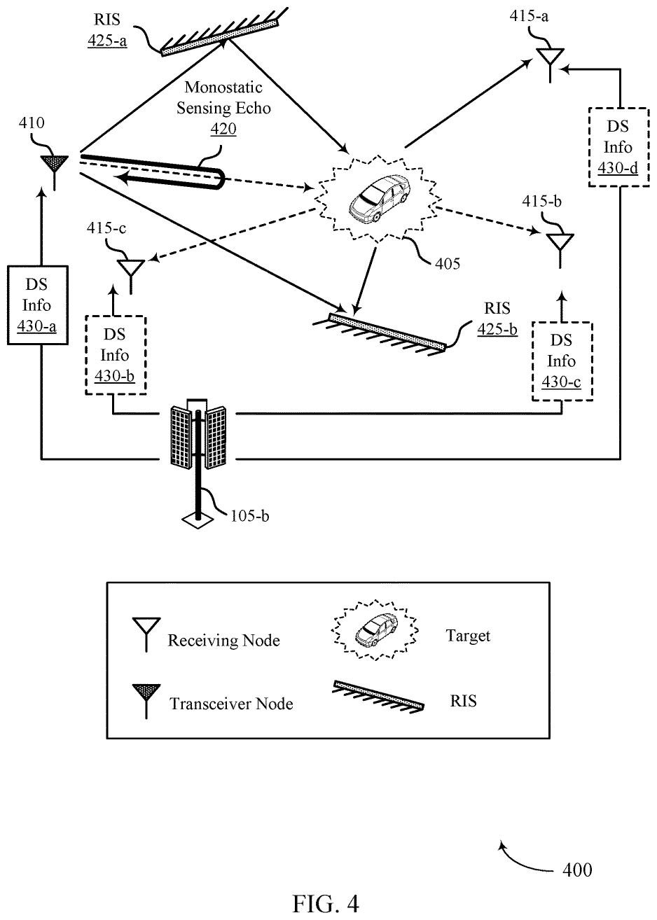

To support distributed sensing using assisting nodes, some systems may use a centralized controller or network entity 105-a to aggregate and distribute distributed sensing information to multiple nodes in the system, and to identify optimal configurations of assisting nodes to help a wireless device accurately characterize a target communication device. In some examples a system may combine aspects of JCR system 300-a and JCR system 300-b. For example, JCR system 300-a may include a sensing target 305 (which may be an example of a vehicle, a UE or network device, or any other moving target), a quantity of transmitting nodes 310, a quantity of transceiver nodes 315, and a quantity of radio head units 320 with sensing capabilities that include the quantity of transmitting nodes 310, the quantity of transceiver nodes 315, or both. The JCR system 300-a may also include a centralized controller or network entity 105-a (which may be an example of a gNB or other network device) that collects information (e.g., feedback information, sensing information, etc.) from nearby transmitting nodes 310, the quantity of transceiver nodes 315, or both, via the quantity of radio head units 320 to enable distributed sensing. JCR system 300-b may include a quantity of transmitting nodes 310 and a quantity of transceiver nodes 315, and a quantity of RISs (e.g., RIS 325-a and RIS 325-b). The JCR system 300-b may employ RIS-aided communication to support additional sensing capabilities for the target 305. For example, the quantity of transmitting nodes 310 and the quantity of transceiver nodes 315 may communicate with the RIS 325-a and the RIS 325-b to obtain additional sensing data from the RISs. In some implementations, such as those described herein and in further detail in FIG. 4, a JCR system may implement RIS aided communication of JCR system 300-a with the centralized controller techniques of JCR system 300-b to characterize a target with increased accuracy. For example, the centralized controller or network entity 105-a may select one or more devices such a plurality of device pairs (such as pairs that include transceiver nodes 315 and RISs 325) that may be used by the transmitting node 310 to accurately sense the target 305.

RISs 325 may also be known also as intelligent reflecting surface (IRS), and large intelligent surface (LIS) may be a programmable structure that may be used to control the propagation of electromagnetic waves by changing the electric and magnetic properties of the surface. In addition to the control of EM waves, RISs may be used to sense the radio environment via the integration of additional sensing capabilities. In some examples, the integration of RISs may at least partially control or alter the characteristics of a radio channel. For example, the RISs 325 may improve the reliability and energy efficiency of the wireless communications system 300 by supporting accurate localization of objects in various environments. In some implementations, such intelligent surfaces may be realized with metasurfaces may support low-complexity and energy efficient transceivers that use relatively fewer active radio frequency (RF) chains.

FIG. 4 illustrates an example of a JCR system 400 that supports distributed sensing with assisting nodes in accordance with one or more aspects of the present disclosure. For example, JCR system 400 may support communications between communications devices such as a transceiver node 410 and receiving node 415-a, 415-b, and 415-c (which may be examples of UEs 105 or network entities 105 described with reference to FIG. 1), a centralized controller or network entity 105-b (which may be an example of a network entity 105 described with reference to FIGS. 1 and 2), and one or more assisting devices (for example, RIS 425-a and RIS 425-b).

JCR system 400 may support assisted distributed sensing using assisting nodes or assisting nodes. For example, the JCR systems may support techniques that allow a transceiver node 410 to accurately characterize a target 405 using any combination of one or more assisting nodes including one or more receiving nodes, one or more RISs, one or more transmitting nodes, one or more reflectors, one or more repeaters, or any combination thereof.

To support distributed sensing using assisting nodes, JCR system 400 may use a centralized controller or network entity 105-b to aggregate and distribute distributed sensing information (e.g., DS info 430-a, DS info 430-b, DS info 430-c, DS info 430-d) to multiple nodes in the system, and to efficiently identify configurations of assisting nodes to help a wireless device accurately characterize a target communication device. A transceiver node 410 (e.g., Tx-0) may sense the target 405 using a monostatic sensing mode (e.g., using the monostatic sensing 420), and may determine that its monostatic sensing mode is insufficient to properly characterize the target 405. To obtain more detailed information about the target 405 (such as shape, velocity, object type, etc.) with enhanced sensing key performance indicators (KPIs), the transceiver node 410 may send a request to a central controller, such as the network entity 105-b, to assist the transceiver node 410 with distributed sensing (e.g., using multi-static sensing mode) using additional receiving nodes and assisting nodes such as RISs. Along with the request, the transceiver node 410 may send its own location, orientation, motion parameters, and a location estimate of the target 405. In response, the transceiver node 410 may receive transmit waveform configurations and beamforming configurations as well as a resource allocation from the centralized controller based on the distributed sensing request.

In some implementations, the centralized controller or network entity 105-a may select one or more receivers and assisting nodes, in particular, the one or more assisting nodes may include paired sets of receivers and assisting nodes (e.g., RISs) for the transceiver node 410 to use to perform distributed sensing. For example, the centralized controller or network entity 105-b may select the RIS 425-a (e.g., RIS A) to be paired with the receiving node 415-a (e.g., Rx-1) as a first assisting pair and the RIS 425-b (e.g., RIS B) to be paired with the receiving node 415-b (e.g., Rx-2) as a second assisting pair. In some examples, the assisting nodes may have reduced capabilities relative to the sets of receivers (e.g., the assisting nodes may be a low-power or zero-power consuming reflector or any other type of assisting node), or may have similar of the same capabilities as the receivers. The centralized controller or network entity 105-b may then indicate the first assisting pair and the second assisting pair along with the receiving node 415-c (e.g., Rx-3) to be used by the transceiver node 410 for performing multi-static sensing. Additionally or alternatively, the centralized controller or the network entity 105-b may configure the beamforming parameters of different transmitting nodes, receiving nodes, RISs, or other assisting nodes in accordance with Tx waveform design parameters.

In some examples, the centralized controller or network entity 105-b may configure beamforming parameters for each assisting pair, and may transmit DS info to each assisting pair using the configured beam. For example, the centralized controller or network entity 105-b may transmit DS info 430-c to the receiving node 415-b which indicates the pairing of the receiving node 415-b with the RIS 425-b to assist the distributed sensing at the transceiver node 410. Additionally or alternatively, the centralized controller or network entity 105-b may transmit DS info 430-d to the receiving node 415-a which indicates the pairing of the receiving node 415-a with the RIS 425-a to assist the distributed sensing at the transceiver node 410. In some examples, in response to the DS info, the receiving node 415-a and the receiving node 415-b may transmit unprocessed multi-static sensing outputs along with an indication of the pairing with respective RISs to the transceiver node 410, to the network entity 105-b, or both. The transceiver node 410 may then translate the sensing output from the one or more assisting devices to accurately determine information about the target 405.

The centralized controller or network entity 105-b may select one or more assisting nodes (e.g., different pairs of assisting nodes) to assist the transceiver node 410 perform distributed sensing based on various factors. For example, the network entity 105-b may select the receiving node 415-b and the RIS 425-b to be an assisting node pair (and the receiving node 415-a and the RIS 425-a to be an assisting node pair) based on distance between the assisting nodes, or based on proximity to the transceiver node 410 or to the target 405. In some other examples, the network entity 105-b may select pairs of assisting nodes based on current or predicted motion of the target 405, based on channel conditions, interference, one or more capabilities of the one or more pairs of assisting devices, a sensing coverage area associated with the one or more pairs of assisting devices, one or more key performance indicators associated with the one or more pairs of assisting devices, or any combination thereof.

The centralized controller or network entity 105-b may then assist the transceiver node 410 to select a set of receiving nodes (e.g., receiving node 415-a, receiving node 415-b, receiving node 415-c) and assisting nodes (e.g., RIS 425-a, RIS 425-b) in the JCR system 400 to help the transceiver node 410 more accurately perform distributed sensing. For example, the centralized controller may send distributed sensing information (e.g., DS info 430-a) to the transceiver node 410 that includes assisting node location, along with information that allows the transceiver node 410 to translate sensing outputs from the assisting nodes in its own reference frame. This DS info 430-a may allow the transceiver node 410 to combine information received from the assisting nodes with its own sensing output to more accurately and efficiently characterize the target 405. After receiving the DS info 430-a from the centralized controller or network entity 105-b, the transceiver node 410 may send a transmit signal and collects distributed sensing outputs from multiple widely separated receiving nodes or assisting nodes. Additionally or alternatively, the centralized controller or network entity 105-b may send DS info (e.g., DS info 430-b, DS info 430-c, and DS info 430-d) to other receiving nodes so that the receiving nodes may perform distributed sensing measurements for the transceiver node 410.

In some examples, one or more receiving nodes and assisting nodes may transmit sensing data outputs directly to the transceiver node 410. In some other examples, the one or more receiving nodes and assisting nodes may transmit the sensing data output indirectly to the transceiver node 410 via the centralized controller or network entity 105-b. For example, the centralized controller or the network entity 105-b may aggregate the multi-static sensing outputs from each receiving node and assisting node and may send the aggregated multi-static sensing outputs to the transceiver node 410.

In some implementations, to further support distributed sensing at the transmitting node, the centralized controller or the network entity 105-b may inform different receiving nodes of assisting node location (e.g., the locations of the RIS 425-a and RIS 425-b) and the location of the transceiver node 410 so that the receiving nodes can automatically translate the frame of reference of the sensing data outputs to be from the frame of reference of the transceiver node 410. For example, the transceiver node 410 may perform a translation (e.g., a linear translation, a rotational translation, or any other type of coordinate or reference frame transformation) from its own inertial frame of reference to an inertial frame associated with receiving nodes. For example, the receiving node 415-a may be paired with an assisting node such as RIS 425-a as an assisting node pair, and may translate the frame of reference from the RIS 425-a reference frame to the reference frame of the transceiver node 410. Additionally or alternatively, the receiving node 415-b may be paired with an assisting node such as RIS 425-b as an assisting node pair, and may translate the frame of reference from the RIS 425-b reference frame to the reference frame of the transceiver node 410. Such sensing data output from receiving nodes could include, for example, location and velocity parameters corresponding to a point cloud of the target 405, center and spread of the range of the target 405, angle (e.g., relative orientation or travel angle of the target 405), and velocity parameters, among other information. In some examples, the point cloud may include a set of coordinates (e.g., three-dimensional coordinates) that describe the geographical location and shape of the target 405 in space. In some examples, the rang of the target 405 may include a motion range of the target 405, including range bounds travelled by the target 405 or orientation range of the target 405. In some other examples, the sensing data output may be raw sensor data from one or more receiving nodes or assisting node pairs (e.g., raw sensor data or a raw signal collected directly from a source device without additional processing from the source device), or sensor data that has been minimally processed for enhanced centralized fusion of the sensor data at the transceiver node 410 or the network entity 105-b.

In some other implementations, the JCR system 400 may include multiple transmitting nodes involved in multi-static sensing with one transmitting node (e.g., transceiver node 410, Tx-0) acting as the initiator node, or a node which initiates the multi-static or distributed sensing. In such implementations, the initiator node (e.g., transceiver node 410) may choose to sense a target in multi-static mode using distributed sensing after performing monostatic sensing 420. To extract information about the target 405 in accordance with enhanced sensing KPIs, the transceiver node 410 may send a request to the network entity 105-b to help the transceiver node 410 sense the target 405 in a multi-static mode using distributed sensing via the additional transmitting nodes, receiving nodes, RISs, other assisting nodes, or any combination thereof.

Upon receiving the request for distributed sensing assistance, the network entity 105-b may select additional nodes (e.g., additional transmitting nodes, receiving nodes, RISs, other assisting nodes, or any combination thereof) to perform multi-static sensing at the transceiver node 410. After being selected by the network entity 105-b to perform distributed sensing, the chosen assisting nodes may receive the waveform and beamforming configurations as well as a resource allocation, and may begin sensing and transmission. In some examples, the network entity 105-b may select the additional transmitting nodes, receiving nodes, RISs, and other assisting nodes, and configurations of each node, based on node location, node capability, sensing coverage area, and sensing KPI (based on sensing application information) under given resource constraints.

After the receiving nodes perform the distributed sensing, the transceiver node 410 (e.g., Tx-0) may receive one or more multi-static sensing outputs from the multiple widely separated receiving nodes and assisting nodes via the network entity 105-b. In some examples, the transceiver node 410 may receive DS info 430-a that includes an indication of the locations of each transmitting node, receiving node, and assisting node (and configurations of each of the transmitting nodes, receiving nodes, and assisting nodes) to allow for the transceiver node 410 to translate the received sensing outputs in its own reference frame, and to combine the received sensing outputs with its own sensing output (e.g., Rx-0). In some examples, the transceiver node 410 may receive the DS info 430-a via a direct link between the transceiver node 410 and the network entity 105-b. In some other examples, the transceiver node 410 may receive the DS info 430-a via a sidelink (e.g., via sidelink mode-1 assisted by the network entity 105-b using a sidelink configured grant) between the transceiver node 410 and another transmitting node, receiving node, or assisting node.

In some implementations, the network entity 105-b may configure the assisting nodes (e.g., RIS 425-a and RIS 425-b) to direct signaling towards paired receiving nodes with low-resolution analog to digital conversion (ADC). For example, the network entity 105-b may dynamically configure the chosen multi-static receiving node (e.g., chosen based on location and adaptable ADC resolution capability of the receiving node) with an ADC resolution that reduces total power consumption. In some such examples, a small cell or coverage area may be densely populated with widely separated receivers supporting low-resolution ADC, and the network entity 105-b may select receiving nodes among these low-resolution receivers to enable assisting node multi-static sensing for reduced power consumption. In such assisting node multi-static sensing, multi-static receiving nodes may achieve low SNR such that using low-resolution ADC provides similar performance as a high resolution ADC with lower power consumption.

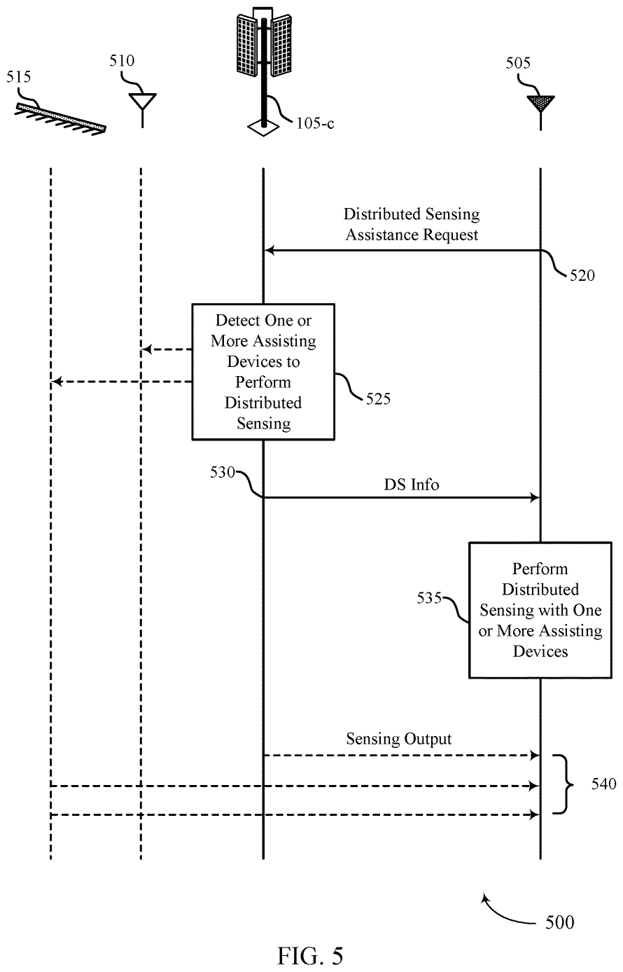

FIG. 5 illustrates an example of a process flow 500 that supports distributed sensing with assisting nodes in accordance with one or more aspects of the present disclosure. The process flow 500 illustrates the communications between a transmitting node 505, a central controller or network entity 105-c, and several assisting nodes such as receiving node 510 and RIS 515. The transmitting node 505, central controller or network entity 105-c, the assisting nodes may be examples of corresponding devices described herein. In the following description of process flow 500, the operations between the devices may be transmitted in a different order than the order shown, or other operations may be added or removed from the process flow 500. For example, some operations may also be left out of process flow 500, may be performed in different orders or at different times, or other operations may be added to process flow 500. Although the transmitting node 505, the central controller or network entity 105-c, and the several assisting nodes are shown performing the operations of process flow 500, some aspects of some operations may also be performed by one or more other wireless or network devices.

At 520, the transmitting node 505 may transmit a message to the network entity 105-c comprising a request for assistance to perform distributed sensing to characterize a target communication device via one or more assisting devices (e.g., receiving node 510 and RIS 515). In some examples, the request for assistance may include a relative location of the transmitting node 505 (e.g., a location of the transmitting node 505 in space, such as a location of the transmitting node 505 relative to other communications devices), a relative orientation of the transmitting node 505, one or more motion parameters associated with the transmitting node 505, an estimate of the relative location of the target communication device, or any combination thereof.

At 525, the network entity 105-c may receive the assistance request message from the transmitting node 505, and may select one or more assisting devices (e.g., receiving node 510 and RIS 515 are one example pair of assisting devices which include at least one receiving device and at least one assisting node) for the transmitting node 505 to use to perform the distributed sensing. In some examples, the network entity 105-c may select the one or more assisting devices based on relative locations of the one or more assisting devices, one or more capabilities of the one or more assisting devices, a sensing coverage area associated with the one or more assisting devices, one or more key performance indicators associated with the one or more assisting devices, or any combination thereof. In some other examples, the network entity 105-c may select the one or more assisting devices based on adaptable ADC capabilities (e.g., low resolution ADC capabilities) of one or more assisting devices, and the network entity 105-c may configure the one or more assisting devices with respective ADC resolutions in accordance with the adaptable ADC capabilities.

At 530, the network entity 105-c may transmit a distributed sensing information (e.g., DS info) message in response to the request. The distributed sensing information message may, in some examples, include configuration information relating to the one or more assisting devices (e.g., one or more receiving devices, one or more RISs, one or more transmitting devices, one or more reflectors, one or more repeaters, or any combination thereof) to use to perform the distributed sensing. In some examples, the distributed sensing information message may include an indication of a transmit waveform including one or more waveform parameters, one or more beamforming parameters, a resource allocation for performing the distributed sensing, or any combination thereof. The transmitting node 505 may receive the distributed sensing info directly from the network entity 105-c via a downlink grant, or the network entity 105-c may configure a sidelink resource grant for the distributed sensing information such that the transmitting node 505 receives the distributed sensing information via a sidelink grant.

At 535, the transmitting node 505 may perform distributed sensing with the one or more assisting devices using the configuration information.

At 540, the transmitting node 505 may receive one or more sets of sensing output information from the one or more assisting device in accordance with the configuration information. In some examples, the transmitting node 505 may receive a first set of sensing output information as one or more sensing outputs from each assisting device or receiving device of the one or more assisting devices, and the transmitting node 505 may combine the one or more sensing outputs in accordance with the distributed sensing information message. The sensing output information may include a set of location and velocity parameters corresponding to a point cloud of the target communication device, one or more range parameters of the target communication device, one or more angle parameters of the target communication device, one or more velocity parameters of the target communication device, or any combination thereof.

In some examples, the transmitting node 505 may receive the one or more sets of sensing output information as a combined set of sensing outputs from each assisting device combined by the network entity 105-c. In some other examples, the one or more sets of sensing output information may be a raw signal collected by the one or more assisting devices.

In some examples, the configuration information includes location information corresponding to the one or more assisting devices, and the transmitting node 505 may use the location information to translate the first set of sensing output information in a first reference system of the one or more assisting devices to a second set of sensing output information in a second reference system of the transmitting node 505. The transmitting node 505 may then combine the second set of sensing output information with a third set of sensing output information (e.g., its own sensing output information).

In some examples, the transmitting node 505 may first attempt to detect the communications target using a monostatic sensing mode, and may determine that monostatic sensing is insufficient for properly characterizing the communications target. The transmitting node 505 may then switch from the monostatic sensing mode to a distributed sensing mode, and may transmit the request for assistance to perform the distributed sensing via the one or more assisting devices. In such examples, the one or more assisting devices may include a pair or combination of receiving wireless devices, transmitting wireless devices, assisting nodes, or any combination thereof.

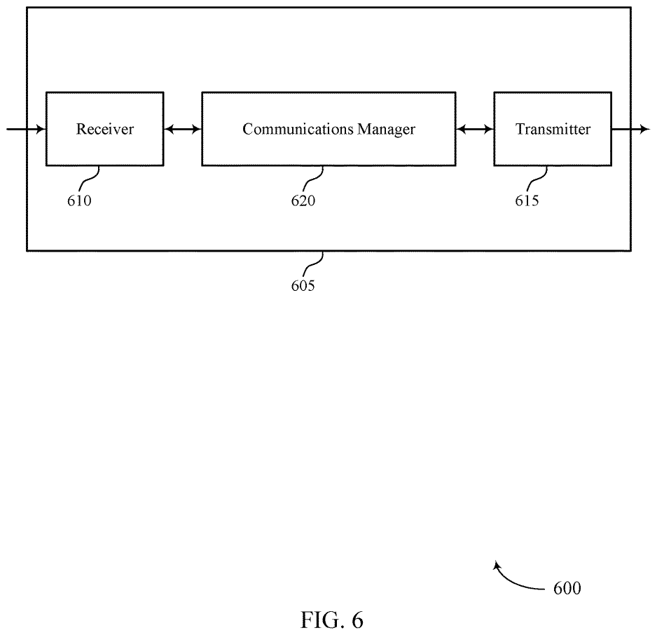

FIG. 6 illustrates a block diagram 600 of a device 605 that supports distributed sensing with assisting nodes in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to distributed sensing with assisting nodes). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to distributed sensing with assisting nodes). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of distributed sensing with assisting nodes as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a wireless device in accordance with examples as disclosed herein. For example, the communications manager 620 may be configured as or otherwise support a means for transmitting a message to a network entity including a request for assistance to perform distributed sensing to characterize a target communication device via a set of multiple assisting devices. The communications manager 620 may be configured as or otherwise support a means for receiving a distributed sensing information message in response to the request, the distributed sensing information message including configuration information for one or more assisting devices to use to perform the distributed sensing. The communications manager 620 may be configured as or otherwise support a means for performing the distributed sensing with the one or more assisting devices based on the configuration information. The communications manager 620 may be configured as or otherwise support a means for receiving a first set of sensing output information from the one or more assisting devices in accordance with the distributed sensing.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, more efficient utilization of communication resources, and more accurate target sensing and detection.

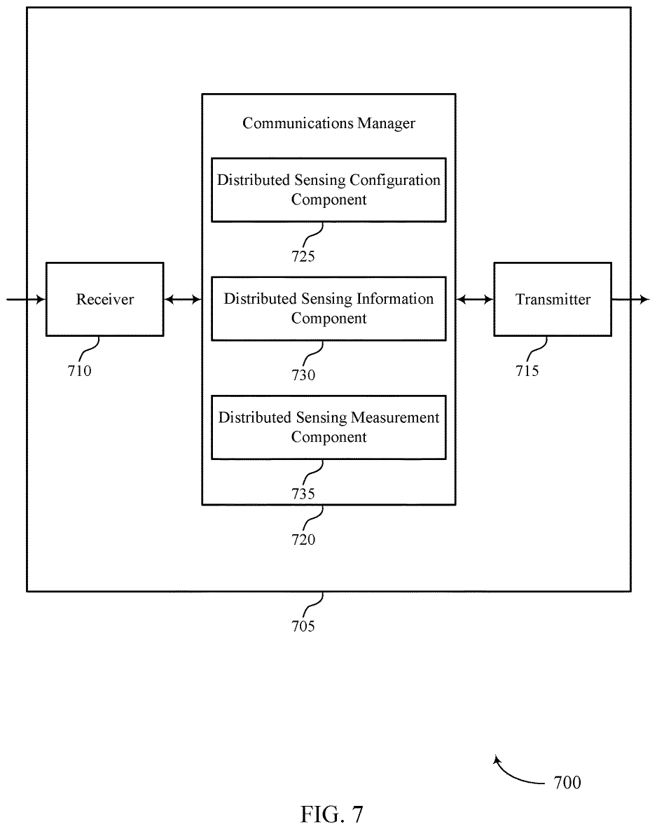

FIG. 7 illustrates a block diagram 700 of a device 705 that supports distributed sensing with assisting nodes in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to distributed sensing with assisting nodes). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to distributed sensing with assisting nodes). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of distributed sensing with assisting nodes as described herein. For example, the communications manager 720 may include a distributed sensing configuration component 725, a distributed sensing information component 730, a distributed sensing measurement component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a wireless device in accordance with examples as disclosed herein. The distributed sensing configuration component 725 may be configured as or otherwise support a means for transmitting a message to a network entity including a request for assistance to perform distributed sensing to characterize a target communication device via a set of multiple assisting devices. The distributed sensing information component 730 may be configured as or otherwise support a means for receiving a distributed sensing information message in response to the request, the distributed sensing information message including configuration information for one or more assisting devices to use to perform the distributed sensing. The distributed sensing measurement component 735 may be configured as or otherwise support a means for performing the distributed sensing with the one or more assisting devices based on the configuration information. The distributed sensing measurement component 735 may be configured as or otherwise support a means for receiving a first set of sensing output information from the one or more assisting devices in accordance with the distributed sensing.

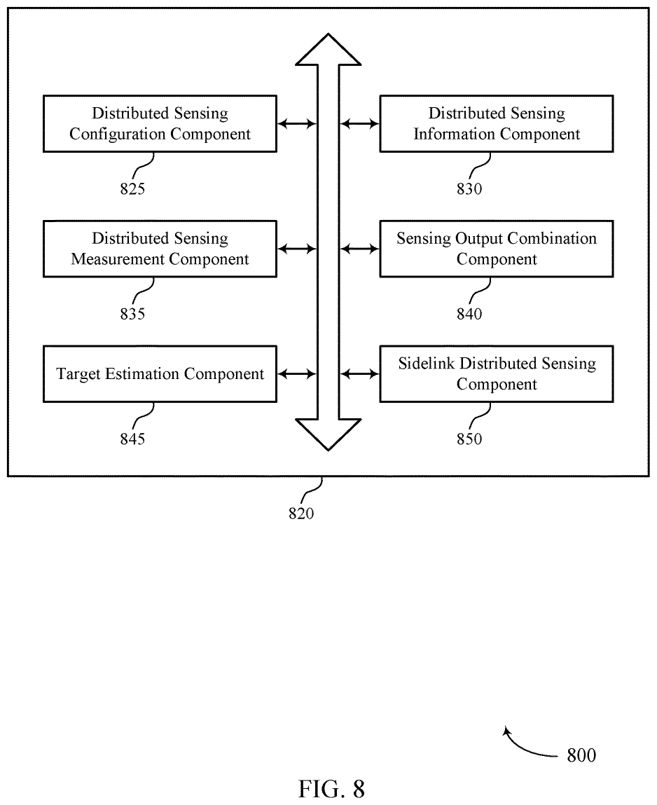

FIG. 8 illustrates a block diagram 800 of a communications manager 820 that supports distributed sensing with assisting nodes in accordance with one or more aspects of the present disclosure. The communications manager 820 may be an example of aspects of a communications manager 620, a communications manager 720, or both, as described herein. The communications manager 820, or various components thereof, may be an example of means for performing various aspects of distributed sensing with assisting nodes as described herein. For example, the communications manager 820 may include a distributed sensing configuration component 825, a distributed sensing information component 830, a distributed sensing measurement component 835, a sensing output combination component 840, a target estimation component 845, a sidelink distributed sensing component 850, or any combination thereof. Each of these components may communicate, directly or indirectly, with one another (e.g., via one or more buses).

The communications manager 820 may support wireless communications at a wireless device in accordance with examples as disclosed herein. The distributed sensing configuration component 825 may be configured as or otherwise support a means for transmitting a message to a network entity including a request for assistance to perform distributed sensing to characterize a target communication device via a set of multiple assisting devices. The distributed sensing information component 830 may be configured as or otherwise support a means for receiving a distributed sensing information message in response to the request, the distributed sensing information message including configuration information for one or more assisting devices to use to perform the distributed sensing. The distributed sensing measurement component 835 may be configured as or otherwise support a means for performing the distributed sensing with the one or more assisting devices based on the configuration information. In some examples, the distributed sensing measurement component 835 may be configured as or otherwise support a means for receiving a first set of sensing output information from the one or more assisting devices in accordance with the distributed sensing.

In some examples, the distributed sensing information message further includes location information corresponding to the one or more assisting devices, and the sensing output combination component 840 may be configured as or otherwise support a means for translating, based on the location information, the first set of sensing output information in a first reference system of the one or more assisting devices to a second set of sensing output information in a second reference system of the wireless device. In some examples, the distributed sensing information message further includes location information corresponding to the one or more assisting devices, and the sensing output combination component 840 may be configured as or otherwise support a means for combining the second set of sensing output information with a third set of sensing output information of the wireless device.

In some examples, to support transmitting the request for assistance to perform the distributed sensing, the target estimation component 845 may be configured as or otherwise support a means for transmitting a relative location of the wireless device, a relative orientation of the wireless device, one or more motion parameters associated with the wireless device, an estimate of the relative location of the target communication device, or any combination thereof.

In some examples, the distributed sensing information message further includes an indication of a transmit waveform including one or more waveform parameters, one or more beamforming parameters, a resource allocation for performing the distributed sensing, or any combination thereof.

In some examples, the one or more assisting devices including at least one receiving device and at least one assisting node.

In some examples, to support receiving the first set of sensing output information, the sensing output combination component 840 may be configured as or otherwise support a means for receiving the first set of sensing output information as one or more sensing outputs from each assisting device of the one or more assisting devices. In some examples, to support receiving the first set of sensing output information, the sensing output combination component 840 may be configured as or otherwise support a means for combining the one or more sensing outputs at the wireless device in accordance with the distributed sensing information message.

In some examples, to support receiving the first set of sensing output information, the sensing output combination component 840 may be configured as or otherwise support a means for receiving, from the network entity, the first set of sensing output information as a combined set of sensing outputs from each assisting device of the one or more assisting devices.

In some examples, the first set of sensing output information includes a set of location and velocity parameters corresponding to a point cloud of the target communication device, one or more range parameters of the target communication device, one or more angle parameters of the target communication device, one or more velocity parameters of the target communication device, or any combination thereof.

In some examples, the first set of sensing output information includes a raw signal collected by the one or more assisting devices.

In some examples, the wireless device includes an initiator wireless node and, to support transmitting the request for assistance, the distributed sensing configuration component 825 may be configured as or otherwise support a means for switching from a monostatic receiving mode to a distributed sensing mode for performing the distributed sensing. In some examples, the wireless device includes an initiator wireless node and, to support transmitting the request for assistance, the distributed sensing configuration component 825 may be configured as or otherwise support a means for transmitting the request for assistance to perform the distributed sensing via the one or more assisting devices, where the one or more assisting devices include one or more receiving wireless devices, one or more transmitting wireless devices, one or more assisting nodes, or any combination thereof.

In some examples, the one or more assisting devices are selected based on relative locations of the one or more assisting devices, one or more capabilities of the one or more assisting devices, a sensing coverage area associated with the one or more assisting devices, one or more key performance indicators associated with the one or more assisting devices, or any combination thereof.

In some examples, to support receiving the distributed sensing information message, the sidelink distributed sensing component 850 may be configured as or otherwise support a means for receiving the distributed sensing information message via a sidelink configured grant from an assisting device of the one or more assisting devices.

In some examples, to support receiving the distributed sensing information message, the distributed sensing configuration component 825 may be configured as or otherwise support a means for receiving the distributed sensing information message via a downlink grant from the network entity.

In some examples, the one or more assisting devices includes one or more receiving devices, one or more reconfigurable intelligent surfaces, one or more transmitting devices, one or more reflectors, one or more repeaters, or any combination thereof.

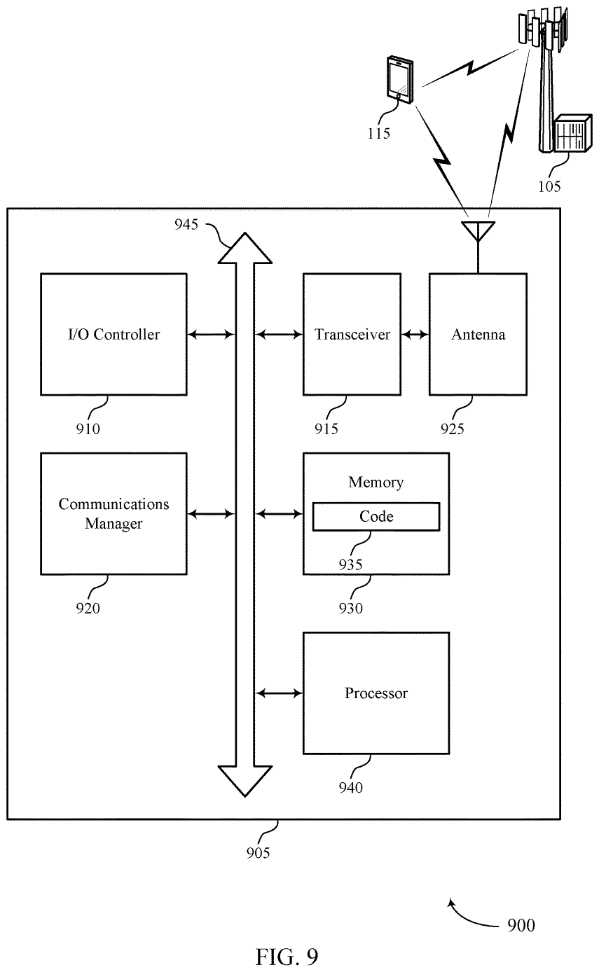

FIG. 9 illustrates a diagram of a system 900 including a device 905 that supports distributed sensing with assisting nodes in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting distributed sensing with assisting nodes). For example, the device 905 or a component of the device 905 may include a processor 940 and memory 930 coupled with or to the processor 940, the processor 940 and memory 930 configured to perform various functions described herein.

The communications manager 920 may support wireless communications at a wireless device in accordance with examples as disclosed herein. For example, the communications manager 920 may be configured as or otherwise support a means for transmitting a message to a network entity including a request for assistance to perform distributed sensing to characterize a target communication device via a set of multiple assisting devices. The communications manager 920 may be configured as or otherwise support a means for receiving a distributed sensing information message in response to the request, the distributed sensing information message including configuration information for one or more assisting devices to use to perform the distributed sensing. The communications manager 920 may be configured as or otherwise support a means for performing the distributed sensing with the one or more assisting devices based on the configuration information. The communications manager 920 may be configured as or otherwise support a means for receiving a first set of sensing output information from the one or more assisting devices in accordance with the distributed sensing.

By including or configuring the communications manager 920 in accordance with examples as described herein, the device 905 may support techniques for improved communication reliability, improved user experience related to reduced processing, reduced power consumption, more efficient utilization of communication resources, improved coordination between devices, improved utilization of processing capability, more accurate target sensing, detection, and characterization including velocity, shape, object type, and location estimates, improved spatial diversity, reduced sensing complexity, and improved coordinated sensing capabilities.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of distributed sensing with assisting nodes as described herein, or the processor 940 and the memory 930 may be otherwise configured to perform or support such operations.

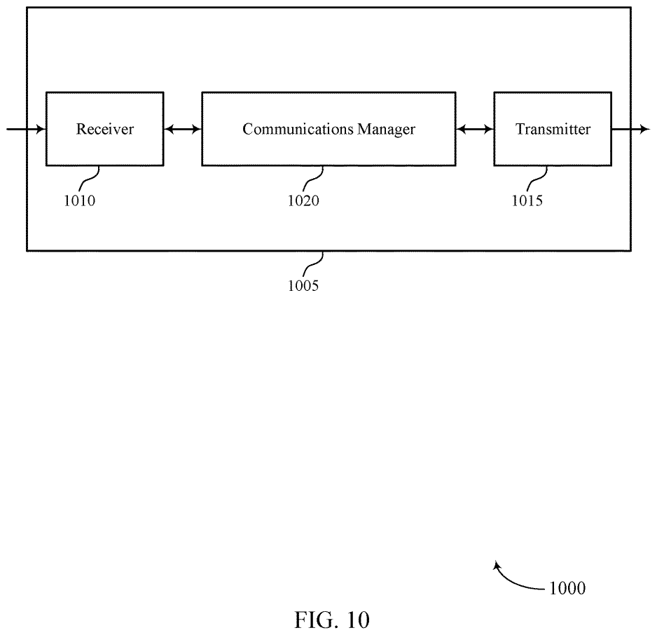

FIG. 10 illustrates a block diagram 1000 of a device 1005 that supports distributed sensing with assisting nodes in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of distributed sensing with assisting nodes as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for receiving a message from a wireless device including a request for assistance to perform distributed sensing via one or more assisting devices in a coverage area to characterize a target communication device. The communications manager 1020 may be configured as or otherwise support a means for detecting one or more assisting devices for the wireless device to use to perform the distributed sensing. The communications manager 1020 may be configured as or otherwise support a means for transmitting a distributed sensing information message in response to the request, the distributed sensing information message including configuration information relating to the one or more assisting devices to use to perform the distributed sensing.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, more efficient utilization of communication resources, and more accurate target sensing and detection.

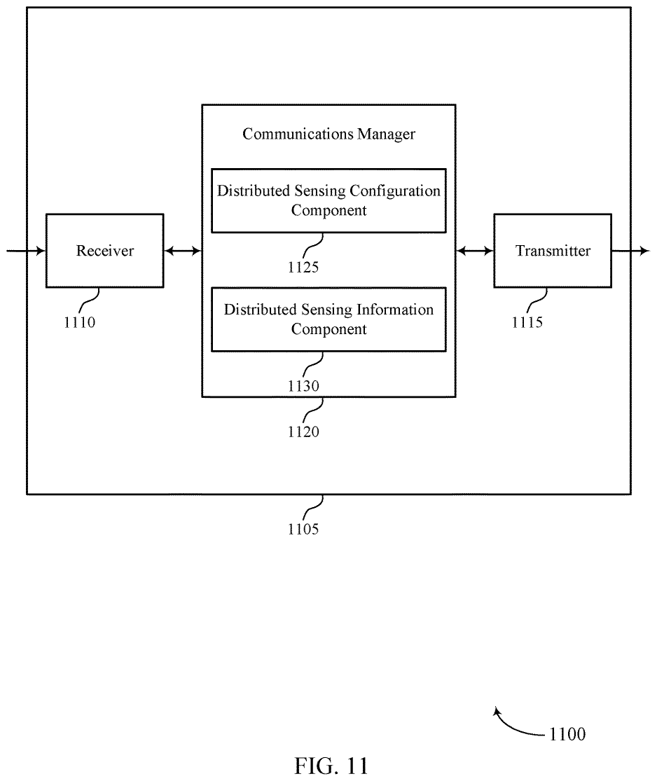

FIG. 11 illustrates a block diagram 1100 of a device 1105 that supports distributed sensing with assisting nodes in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of distributed sensing with assisting nodes as described herein. For example, the communications manager 1120 may include a distributed sensing configuration component 1125, a distributed sensing information component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The distributed sensing configuration component 1125 may be configured as or otherwise support a means for receiving a message from a wireless device including a request for assistance to perform distributed sensing via one or more assisting devices in a coverage area to characterize a target communication device. The distributed sensing configuration component 1125 may be configured as or otherwise support a means for detecting one or more assisting devices for the wireless device to use to perform the distributed sensing. The distributed sensing information component 1130 may be configured as or otherwise support a means for transmitting a distributed sensing information message in response to the request, the distributed sensing information message including configuration information relating to the one or more assisting devices to use to perform the distributed sensing.

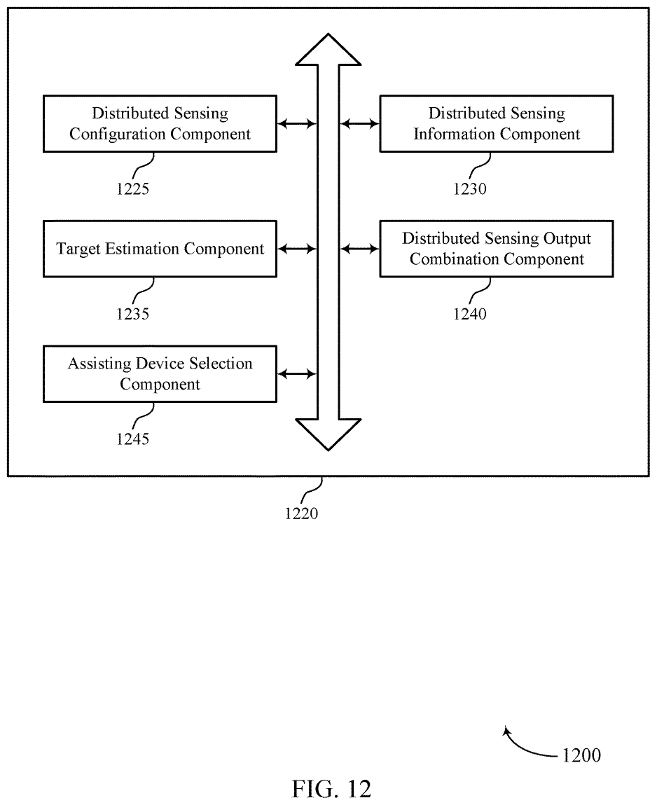

FIG. 12 illustrates a block diagram 1200 of a communications manager 1220 that supports distributed sensing with assisting nodes in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of distributed sensing with assisting nodes as described herein. For example, the communications manager 1220 may include a distributed sensing configuration component 1225, a distributed sensing information component 1230, a target estimation component 1235, a distributed sensing output combination component 1240, an assisting device selection component 1245, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The distributed sensing configuration component 1225 may be configured as or otherwise support a means for receiving a message from a wireless device including a request for assistance to perform distributed sensing via one or more assisting devices in a coverage area to characterize a target communication device. In some examples, the distributed sensing configuration component 1225 may be configured as or otherwise support a means for detecting one or more assisting devices for the wireless device to use to perform the distributed sensing. The distributed sensing information component 1230 may be configured as or otherwise support a means for transmitting a distributed sensing information message in response to the request, the distributed sensing information message including configuration information relating to the one or more assisting devices to use to perform the distributed sensing.

In some examples, the distributed sensing information message further includes location information for a first set of sensing output information to be translated from a first reference frame of the one or more assisting devices to a second reference frame of the wireless device.

In some examples, to support receiving the request for assistance to perform the distributed sensing, the target estimation component 1235 may be configured as or otherwise support a means for receiving, from the wireless device, a relative location of the wireless device, a relative orientation of the wireless device, one or more motion parameters associated with the wireless device, an estimate of the relative location of the target communication device, or any combination thereof.

In some examples, the distributed sensing information message further includes an indication of a transmit waveform including one or more waveform parameters, one or more beamforming parameters, a resource allocation for performing the distributed sensing, or any combination thereof.

In some examples, the one or more assisting devices include at least one receiving device and at least one assisting node.

In some examples, the distributed sensing output combination component 1240 may be configured as or otherwise support a means for transmitting, to the wireless device, a first set of sensing output information as a combined set of sensing outputs from each assisting device of the one or more assisting devices.

In some examples, the first set of sensing output information includes a set of location and velocity parameters corresponding to a point cloud of the target communication device, one or more range parameters of the target communication device, one or more angle parameters of the target communication device, one or more velocity parameters of the target communication device, or any combination thereof.

In some examples, to support receiving the request for assistance, the distributed sensing configuration component 1225 may be configured as or otherwise support a means for receiving, from the wireless device, the request for assistance to perform the distributed sensing via the one or more assisting devices, where the one or more assisting devices include one or more receiving wireless devices, one or more transmitting wireless devices, one or more assisting nodes, or any combination thereof.

In some examples, the one or more assisting devices are selected based on relative locations of the one or more assisting devices, one or more capabilities of the one or more assisting devices, a sensing coverage area associated with the one or more assisting devices, one or more key performance indicators associated with the one or more assisting devices, or any combination thereof.

In some examples, to support transmitting the distributed sensing information message, the distributed sensing configuration component 1225 may be configured as or otherwise support a means for transmitting a sidelink configured grant for communicating the distributed sensing information message with the wireless device via an assisting device of the one or more assisting devices.

In some examples, to support transmitting the distributed sensing information message, the distributed sensing configuration component 1225 may be configured as or otherwise support a means for transmitting the distributed sensing information message via a downlink grant to the wireless device.

In some examples, the assisting device selection component 1245 may be configured as or otherwise support a means for selecting the one or more assisting devices based on adaptable analog to digital conversion capabilities of one or more assisting devices. In some examples, the assisting device selection component 1245 may be configured as or otherwise support a means for configuring the one or more assisting devices with respective analog to digital conversion resolutions in accordance with the adaptable analog to digital conversion capabilities.

In some examples, the respective analog to digital conversion resolutions include low resolution analog to digital conversion resolutions.

In some examples, the one or more assisting devices include one or more receiving devices, one or more reconfigurable intelligent surfaces, one or more transmitting devices, one or more reflectors, one or more repeaters, or any combination thereof.

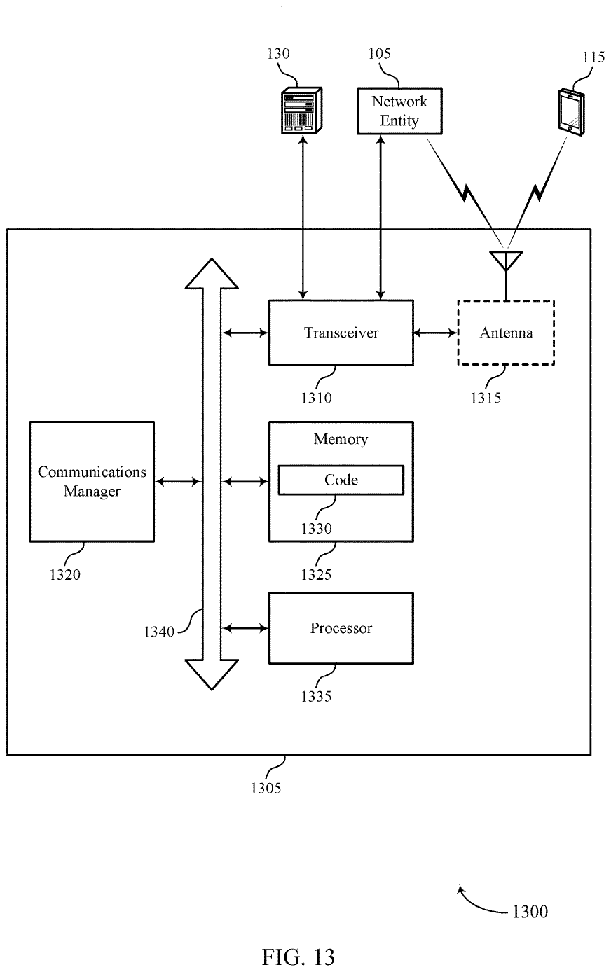

FIG. 13 illustrates a diagram of a system 1300 including a device 1305 that supports distributed sensing with assisting nodes in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting distributed sensing with assisting nodes). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for receiving a message from a wireless device including a request for assistance to perform distributed sensing via one or more assisting devices in a coverage area to characterize a target communication device. The communications manager 1320 may be configured as or otherwise support a means for detecting one or more assisting devices for the wireless device to use to perform the distributed sensing. The communications manager 1320 may be configured as or otherwise support a means for transmitting a distributed sensing information message in response to the request, the distributed sensing information message including configuration information relating to the one or more assisting devices to use to perform the distributed sensing.

By including or configuring the communications manager 1320 in accordance with examples as described herein, the device 1305 may support techniques for improved communication reliability, improved user experience related to reduced processing, reduced power consumption, more efficient utilization of communication resources, improved coordination between devices, improved utilization of processing capability, more accurate target sensing, detection, and characterization including velocity, shape, object type, and location estimates, improved spatial diversity, reduced sensing complexity, and improved coordinated sensing capabilities.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of distributed sensing with assisting nodes as described herein, or the processor 1335 and the memory 1325 may be otherwise configured to perform or support such operations.

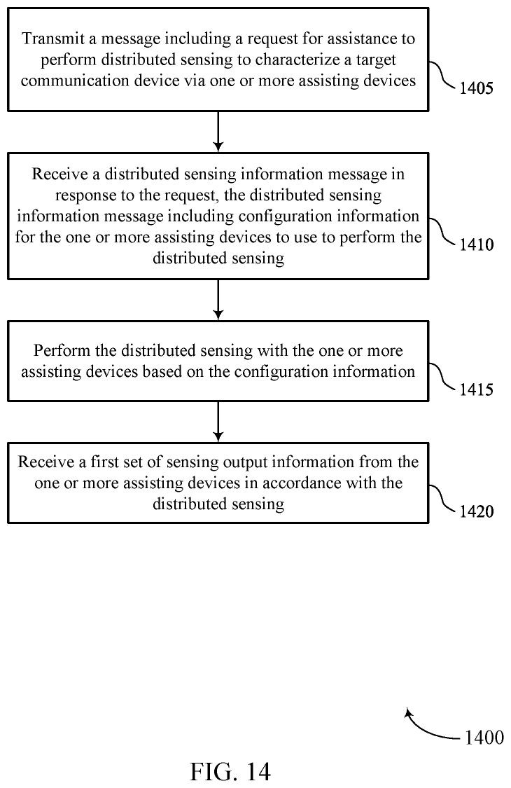

FIG. 14 illustrates a flowchart showing a method 1400 that supports distributed sensing with assisting nodes in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting a message to a network entity including a request for assistance to perform distributed sensing to characterize a target communication device via a set of multiple assisting devices. The operations of 1405 may be performed in accordance with examples as disclosed herein. In some examples, aspects of the operations of 1405 may be performed by a distributed sensing configuration component 825 as described with reference to FIG. 8.

At 1410, the method may include receiving a distributed sensing information message in response to the request, the distributed sensing information message including configuration information for one or more assisting devices to use to perform the distributed sensing. The operations of 1410 may be performed in accordance with examples as disclosed herein. In some examples, aspects of the operations of 1410 may be performed by a distributed sensing information component 830 as described with reference to FIG. 8.

At 1415, the method may include performing the distributed sensing with the one or more assisting devices based on the configuration information. The operations of 1415 may be performed in accordance with examples as disclosed herein. In some examples, aspects of the operations of 1415 may be performed by a distributed sensing measurement component 835 as described with reference to FIG. 8.

At 1420, the method may include receiving a first set of sensing output information from the one or more assisting devices in accordance with the distributed sensing. The operations of 1420 may be performed in accordance with examples as disclosed herein. In some examples, aspects of the operations of 1420 may be performed by a distributed sensing measurement component 835 as described with reference to FIG. 8.

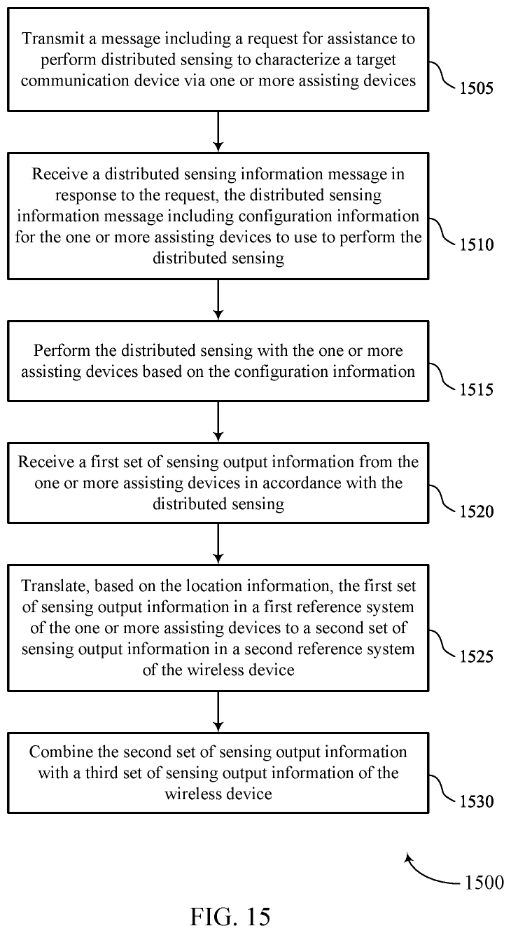

FIG. 15 illustrates a flowchart showing a method 1500 that supports distributed sensing with assisting nodes in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting a message to a network entity including a request for assistance to perform distributed sensing to characterize a target communication device via a set of multiple assisting devices. The operations of 1505 may be performed in accordance with examples as disclosed herein. In some examples, aspects of the operations of 1505 may be performed by a distributed sensing configuration component 825 as described with reference to FIG. 8.

At 1510, the method may include receiving a distributed sensing information message in response to the request, the distributed sensing information message including configuration information for one or more assisting devices to use to perform the distributed sensing. The operations of 1510 may be performed in accordance with examples as disclosed herein. In some examples, aspects of the operations of 1510 may be performed by a distributed sensing information component 830 as described with reference to FIG. 8.

At 1515, the method may include performing the distributed sensing with the one or more assisting devices based on the configuration information. The operations of 1515 may be performed in accordance with examples as disclosed herein. In some examples, aspects of the operations of 1515 may be performed by a distributed sensing measurement component 835 as described with reference to FIG. 8.

At 1520, the method may include receiving a first set of sensing output information from the one or more assisting devices in accordance with the distributed sensing. The operations of 1520 may be performed in accordance with examples as disclosed herein. In some examples, aspects of the operations of 1520 may be performed by a distributed sensing measurement component 835 as described with reference to FIG. 8.

At 1525, the method may include translating, based on the location information, the first set of sensing output information in a first reference system of the one or more assisting devices to a second set of sensing output information in a second reference system of the wireless device. The operations of 1525 may be performed in accordance with examples as disclosed herein. In some examples, aspects of the operations of 1525 may be performed by a sensing output combination component 840 as described with reference to FIG. 8.

At 1530, the method may include combining the second set of sensing output information with a third set of sensing output information of the wireless device. The operations of 1530 may be performed in accordance with examples as disclosed herein. In some examples, aspects of the operations of 1530 may be performed by a sensing output combination component 840 as described with reference to FIG. 8.

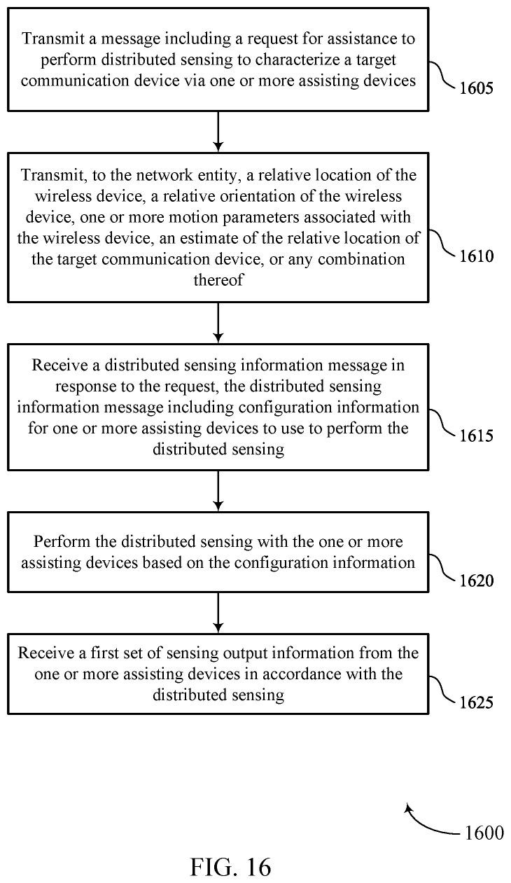

FIG. 16 illustrates a flowchart showing a method 1600 that supports distributed sensing with assisting nodes in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include transmitting a message to a network entity including a request for assistance to perform distributed sensing to characterize a target communication device via a set of multiple assisting devices. The operations of 1605 may be performed in accordance with examples as disclosed herein. In some examples, aspects of the operations of 1605 may be performed by a distributed sensing configuration component 825 as described with reference to FIG. 8.

At 1610, the method may include transmitting (e.g., to a network entity) a relative location of the wireless device, a relative orientation of the wireless device, one or more motion parameters associated with the wireless device, an estimate of the relative location of the target communication device, or any combination thereof. The operations of 1610 may be performed in accordance with examples as disclosed herein. In some examples, aspects of the operations of 1610 may be performed by a target estimation component 845 as described with reference to FIG. 8.

At 1615, the method may include receiving a distributed sensing information message in response to the request, the distributed sensing information message including configuration information for one or more assisting devices to use to perform the distributed sensing. The operations of 1615 may be performed in accordance with examples as disclosed herein. In some examples, aspects of the operations of 1615 may be performed by a distributed sensing information component 830 as described with reference to FIG. 8.

At 1620, the method may include performing the distributed sensing with the one or more assisting devices based on the configuration information. The operations of 1620 may be performed in accordance with examples as disclosed herein. In some examples, aspects of the operations of 1620 may be performed by a distributed sensing measurement component 835 as described with reference to FIG. 8.

At 1625, the method may include receiving a first set of sensing output information from the one or more assisting devices in accordance with the distributed sensing. The operations of 1625 may be performed in accordance with examples as disclosed herein. In some examples, aspects of the operations of 1625 may be performed by a distributed sensing measurement component 835 as described with reference to FIG. 8.

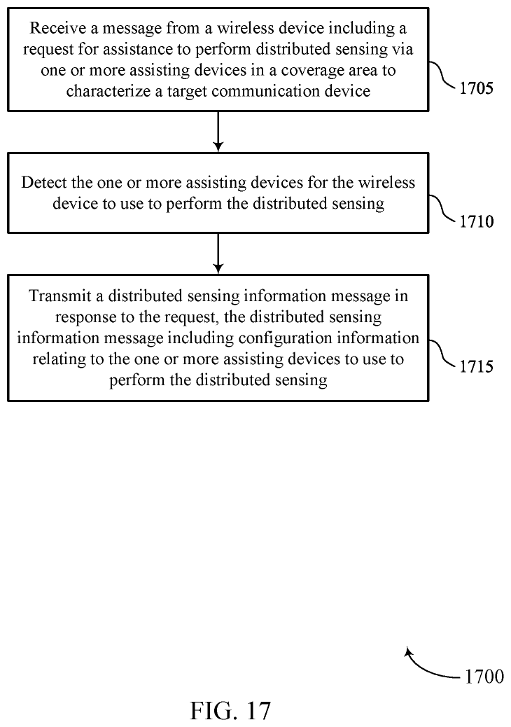

FIG. 17 illustrates a flowchart showing a method 1700 that supports distributed sensing with assisting nodes in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include receiving a message from a wireless device including a request for assistance to perform distributed sensing via one or more assisting devices in a coverage area to characterize a target communication device. The operations of 1705 may be performed in accordance with examples as disclosed herein. In some examples, aspects of the operations of 1705 may be performed by a distributed sensing configuration component 1225 as described with reference to FIG. 12.

At 1710, the method may include detecting one or more assisting devices for the wireless device to use to perform the distributed sensing. The operations of 1710 may be performed in accordance with examples as disclosed herein. In some examples, aspects of the operations of 1710 may be performed by a distributed sensing configuration component 1225 as described with reference to FIG. 12.

At 1715, the method may include transmitting a distributed sensing information message in response to the request, the distributed sensing information message including configuration information relating to the one or more assisting devices to use to perform the distributed sensing. The operations of 1715 may be performed in accordance with examples as disclosed herein. In some examples, aspects of the operations of 1715 may be performed by a distributed sensing information component 1230 as described with reference to FIG. 12.

The following provides an overview of aspects of the present disclosure:

Aspect 1: A method for wireless communications at a wireless device, comprising: transmitting a message to a network entity comprising a request for assistance to perform distributed sensing to characterize a target communication device via one or more assisting devices; receiving a distributed sensing information message in response to the request, the distributed sensing information message comprising configuration information for one or more assisting devices to use to perform the distributed sensing; performing the distributed sensing with the one or more assisting devices based at least in part on the configuration information; and receiving a first set of sensing output information from the one or more assisting devices in accordance with the distributed sensing.

Aspect 2: The method of aspect 1, wherein the distributed sensing information message further comprises location information corresponding to the one or more assisting devices, the method further comprising: translating, based at least in part on the location information, the first set of sensing output information in a first reference system of the one or more assisting devices to a second set of sensing output information in a second reference system of the wireless device; and combining the second set of sensing output information with a third set of sensing output information of the wireless device.

Aspect 3: The method of any of aspects 1 through 2, wherein transmitting the request for assistance to perform the distributed sensing further comprises: transmitting, to the network entity, a relative location of the wireless device, a relative orientation of the wireless device, one or more motion parameters associated with the wireless device, an estimate of the relative location of the target communication device, or any combination thereof.

Aspect 4: The method of any of aspects 1 through 3, wherein the distributed sensing information message further comprises an indication of a transmit waveform including one or more waveform parameters, one or more beamforming parameters, a resource allocation for performing the distributed sensing, or any combination thereof.

Aspect 5: The method of any of aspects 1 through 4, wherein the one or more assisting devices comprise at least one receiving device and at least one assisting node.

Aspect 6: The method of any of aspects 1 through 5, wherein receiving the first set of sensing output information further comprises: receiving the first set of sensing output information as one or more sensing outputs from each assisting device of the one or more assisting devices; and combining the one or more sensing outputs at the wireless device in accordance with the distributed sensing information message.

Aspect 7: The method of any of aspects 1 through 6, wherein receiving the first set of sensing output information further comprises: receiving, from the network entity, the first set of sensing output information as a combined set of sensing outputs from each assisting device of the one or more assisting devices.

Aspect 8: The method of any of aspects 1 through 7, wherein the first set of sensing output information comprises a set of location and velocity parameters corresponding to a point cloud of the target communication device, one or more range parameters of the target communication device, one or more angle parameters of the target communication device, one or more velocity parameters of the target communication device, or any combination thereof.

Aspect 9: The method of any of aspects 1 through 8, wherein the first set of sensing output information comprises a raw signal collected by the one or more assisting devices.

Aspect 10: The method of any of aspects 1 through 9, wherein the wireless device comprises an initiator wireless node, and transmitting the request for assistance further comprises: switching from a monostatic receiving mode to a distributed sensing mode for performing the distributed sensing; and transmitting, to the network entity, the request for assistance to perform the distributed sensing via the one or more assisting devices, wherein the one or more assisting devices comprise one or more receiving wireless devices, one or more transmitting wireless devices, one or more assisting nodes, or any combination thereof.

Aspect 11: The method of any of aspects 1 through 10, wherein the one or more assisting devices are selected based at least in part on relative locations of the one or more assisting devices, one or more capabilities of the one or more assisting devices, a sensing coverage area associated with the one or more assisting devices, one or more KPIs associated with the one or more assisting devices, or any combination thereof.

Aspect 12: The method of any of aspects 1 through 11, wherein receiving the distributed sensing information message further comprises: receiving the distributed sensing information message via a sidelink configured grant from an assisting device of the one or more assisting devices.

Aspect 13: The method of any of aspects 1 through 12, wherein receiving the distributed sensing information message further comprises: receiving the distributed sensing information message via a downlink grant from the network entity.

Aspect 14: The method of any of aspects 1 through 13, wherein the one or more assisting devices comprise one or more receiving devices, one or more RISs, one or more transmitting devices, one or more reflectors, one or more repeaters, or any combination thereof.

Aspect 15: A method for wireless communications at a network entity, comprising: receiving a message from a wireless device comprising a request for assistance to perform distributed sensing via one or more assisting devices in a coverage area to characterize a target communication device; detecting one or more assisting devices for the wireless device to use to perform the distributed sensing; and transmitting a distributed sensing information message in response to the request, the distributed sensing information message comprising configuration information relating to the one or more assisting devices to use to perform the distributed sensing.

Aspect 16: The method of aspect 15, wherein the distributed sensing information message further comprises location information for a first set of sensing output information to be translated from a first reference frame of the one or more assisting devices to a second reference frame of the wireless device.

Aspect 17: The method of any of aspects 15 through 16, wherein receiving the request for assistance to perform the distributed sensing further comprises: receiving, from the wireless device, a relative location of the wireless device, a relative orientation of the wireless device, one or more motion parameters associated with the wireless device, an estimate of the relative location of the target communication device, or any combination thereof.

Aspect 18: The method of any of aspects 15 through 17, wherein the distributed sensing information message further comprises an indication of a transmit waveform including one or more waveform parameters, one or more beamforming parameters, a resource allocation for performing the distributed sensing, or any combination thereof.

Aspect 19: The method of any of aspects 15 through 18, wherein the one or more assisting devices comprise at least one receiving device and at least one assisting node.

Aspect 20: The method of any of aspects 15 through 19, further comprising: transmitting, to the wireless device, a first set of sensing output information as a combined set of sensing outputs from each assisting device of the one or more assisting devices.

Aspect 21: The method of aspect 20, wherein the first set of sensing output information comprises a set of location and velocity parameters corresponding to a point cloud of the target communication device, one or more range parameters of the target communication device, one or more angle parameters of the target communication device, one or more velocity parameters of the target communication device, or any combination thereof.

Aspect 22: The method of any of aspects 15 through 21, wherein receiving the request for assistance further comprises: receiving, from the wireless device, the request for assistance to perform the distributed sensing via the one or more assisting devices, wherein the one or more assisting devices comprise one or more receiving wireless devices, one or more transmitting wireless devices, one or more assisting nodes, or any combination thereof.

Aspect 23: The method of any of aspects 15 through 22, wherein the one or more assisting devices are selected based at least in part on relative locations of the one or more assisting devices, one or more capabilities of the one or more assisting devices, a sensing coverage area associated with the one or more assisting devices, one or more KPIs associated with the one or more assisting devices, or any combination thereof.

Aspect 24: The method of any of aspects 15 through 23, wherein transmitting the distributed sensing information message further comprises: transmitting a sidelink configured grant for communicating the distributed sensing information message with the wireless device via an assisting device of the one or more assisting devices.

Aspect 25: The method of any of aspects 15 through 24, wherein transmitting the distributed sensing information message further comprises: transmitting the distributed sensing information message via a downlink grant to the wireless device.

Aspect 26: The method of any of aspects 15 through 25, further comprising: selecting the one or more assisting devices based at least in part on adaptable ADC capabilities of one or more assisting devices; and configuring the one or more assisting devices with respective ADC resolutions in accordance with the adaptable ADC capabilities.

Aspect 27: The method of aspect 26, wherein the respective analog to digital conversion resolutions comprise low resolution ADC resolutions.

Aspect 28: The method of any of aspects 15 through 27, wherein the one or more assisting devices comprise one or more receiving devices, one or more RISs, one or more transmitting devices, one or more reflectors, one or more repeaters, or any combination thereof.

Aspect 29: An apparatus for wireless communications at a wireless device, comprising a processor; memory coupled with the processor; and instructions stored in the memory and executable by the processor to cause the apparatus to perform a method of any of aspects 1 through 14.

Aspect 30: An apparatus for wireless communications at a wireless device, comprising at least one means for performing a method of any of aspects 1 through 14.

Aspect 31: A non-transitory computer-readable medium storing code for wireless communications at a wireless device, the code comprising instructions executable by a processor to perform a method of any of aspects 1 through 14.

Aspect 32: A computer program comprising code for wireless communications that, when executed on a processor of a wireless device, cause the processor to perform a method of any of aspects 1 through 14.

Aspect 33: An apparatus for wireless communications at a network entity, comprising a processor; memory coupled with the processor; and instructions stored in the memory and executable by the processor to cause the apparatus to perform a method of any of aspects 15 through 28.

Aspect 34: An apparatus for wireless communications at a network entity, comprising at least one means for performing a method of any of aspects 15 through 28.

Aspect 35: A non-transitory computer-readable medium storing code for wireless communications at a network entity, the code comprising instructions executable by a processor to perform a method of any of aspects 15 through 28.

Aspect 36: A computer program comprising code for wireless communications that, when executed on a processor of a network entity, cause the processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a wireless device, comprising:
a processor:
memory coupled with the processor; and
instructions stored in the memory' and executable by the processor to cause the apparatus to:
transmit a message comprising a request for assistance to perform distributed sensing to characterize a target communication device via one or more assisting devices;
receive a distributed sensing information message in response to the request, the distributed sensing information message comprising configuration information for the one or more assisting devices to use to perform the distributed sensing;
perform the distributed sensing with the one or more assisting devices based at least in part on the configuration information; and
receive a first set of sensing output information from the one or more assisting devices in accordance with the distributed sensing.

2. The apparatus of claim 1, wherein the distributed sensing information message further comprises location information corresponding to the one or more assisting devices, and the instructions are further executable by the processor to cause the apparatus to:
translate, based at least in part on the location information, the first set of sensing output information in a first reference system of the one or more assisting devices to a second set of sensing output information in a second reference system of the wireless device; and
combine the second set of sensing output information with a third set of sensing output information of the wireless device.

3. The apparatus of claim 1, wherein the message comprising the request for assistance is transmitted to a network entity and wherein the instructions to transmit the request for assistance to perform the distributed sensing are further executable by the processor to cause the apparatus to:
transmit, to the network entity, a relative location of the wireless device, a relative orientation of the wireless device, one or more motion parameters associated with the wireless device, an estimate of the relative location of the target communication device, or any combination thereof.

4. The apparatus of claim 1, wherein the distributed sensing information message further comprises an indication of a transmit waveform including one or more waveform parameters, one or more beamforming parameters, a resource allocation for performing the distributed sensing, or any combination thereof.

5. The apparatus of claim 1, wherein:
the one or more assisting devices comprise at least one receiving device and at least one assisting node.

6. The apparatus of claim 1. wherein the instructions to receive the first set of sensing output information are further executable by the processor to cause the apparatus to:
receive the first set of sensing output information as one or more sensing outputs from each assisting device of the one or more assisting devices: and combine the one or more sensing outputs at the wireless device in accordance with the distributed sensing information message.

7. The apparatus of claim 1, wherein the message comprising the request for assistance is transmitted to a network entity and wherein the instructions to receive the first set of sensing output information are further executable by the processor to cause the apparatus to:
receive, from the network entity, the first set of sensing output information as a combined set of sensing outputs from each assisting device of the one or more assisting devices.

8. The apparatus of claim 1, wherein the first set of sensing output information comprises a set of location and velocity parameters corresponding to a point cloud of the target communication device, one or more range parameters of the target communication device, one or more angle parameters of the target communication device, one or more velocity parameters of the target communication device, or any combination thereof.

9. The apparatus of claim 1, wherein the first set of sensing output information comprises a raw signal collected by the one or more assisting devices.

10. The apparatus of claim 1, wherein the wireless device comprises an initiator wireless node, and the instructions to transmit the request for assistance are further executable by the processor to cause the apparatus to:
switch from a monostatic receiving mode to a distributed sensing mode for performing the distributed sensing: and
transmit the request for assistance to perform the distributed sensing via the one or more assisting devices, wherein the one or more assisting devices comprise one or more receiving wireless devices, one or more transmitting wireless devices, one or more assisting nodes, or any combination thereof.

11. The apparatus of claim 1, wherein the one or more assisting devices are selected based at least in part on relative locations of the one or more assisting devices, one or more capabilities of the one or more assisting devices, a sensing coverage area associated with the one or more assisting devices, one or more key performance indicators associated with the one or more assisting devices, or any combination thereof.

12. The apparatus of claim 1, wherein the instructions to receive the distributed sensing information message are further executable by the processor to cause the apparatus to:
receive the distributed sensing information message via a sidelink configured grant.

13. The apparatus of claim 1, wherein the message comprising the request for assistance is transmitted to a network entity and wherein the instructions to receive the distributed sensing information message are further executable by the processor to cause the apparatus to:
receive the distributed sensing information message via a downlink grant from the network entity.

14. The apparatus of claim 1. wherein the one or more assisting devices comprise one or more receiving devices, one or more reconfigurable intelligent surfaces, one or more transmitting devices, one or more reflectors, one or more repeaters, or any combination thereof.

15. An apparatus for wireless communications at a network entity, comprising:
a processor:
memory coupled with the processor; and
instructions stored in the memory and executable by the processor to cause the apparatus to:
receive a message from a wireless device comprising a request for assistance to perform distributed sensing via one or more assisting devices in a coverage area to characterize a target communication device;
detect the one or more assisting devices for the wireless device to use to perform the distributed sensing; and
transmit a distributed sensing information message in response to the request, the distributed sensing information message comprising configuration information relating to the one or more assisting devices to use to perform the distributed sensing.

16. The apparatus of claim 15, wherein the distributed sensing information message further comprises location information for a first set of sensing output information to be translated from a first reference system of the one or more assisting devices to a second reference system of the wireless device.

17. The apparatus of claim 15, wherein the instructions to receive the request for assistance to perform the distributed sensing are further executable by the processor to cause the apparatus to:
receive, from the wireless device, a relative location of the wireless device, a relative orientation of the wireless device, one or more motion parameters associated with the wireless device, an estimate of the relative location of the target communication device, or any combination thereof.

18. The apparatus of claim 15, wherein the distributed sensing information message further comprises an indication of a transmit waveform including one or more waveform parameters, one or more beamforming parameters, a resource allocation for performing the distributed sensing, or any combination thereof.

19. The apparatus of claim 15, wherein:
the one or more assisting devices comprise at least one receiving device and at least one assisting node.

20. The apparatus of claim 15, wherein the instructions are further executable by the processor to cause the apparatus to:
transmit, to the wireless device, a first set of sensing output information as a combined set of sensing outputs from each assisting device of the one or more assisting devices.

21-30. (canceled)
